(19) United States
(12) Patent Application Publication
(10) Pub. No.: US 2012/0327450 A1
(43) Pub. Date: Dec. 27, 2012

(54) METHODS AND DEVICES FOR SECURING AND AUTHENTICATING DOCUMENTS

(75) Inventors: Zbigniew Sagan, Rueil-Malmaison (FR); Alain Foucou, Rueil-Malmaison (FR); Jean-Pierre Massicot, Rueil-Malmaison (FR)

(73) Assignee: ADVANCED TRACK & TRACE, Rueil Malmaison (FR)

(21) Appl. No.: 12/374,536

(22) PCT Filed: Jul. 19, 2007
(86) PCT No.: PCT/FR07/01246

§ 371 Date: Jul. 19, 2012

(30) Foreign Application Priority Data
Jul. 19, 2006 (FR) 0606588
Dec. 26, 2006 (FR) 0611402
Jun. 1, 2007 (FR) 0703922

(51) Int. Cl. G06K 15/02

(52) U.S. Cl. 358/1.14

(57) ABSTRACT

A method for securing a document, includes:
a step of determining print conditions of the document;
a step of determining physical characteristics of cells of at least one shape, according to the print conditions, such that the proportion of cells printed with a print error coming solely from unanticipated unknowns in printing is greater than a pre-defined first value and less than a pre-defined second value;
a step of representing an item of information by varying the appearance of cells presenting the physical characteristics and
a step of printing the shape utilizing the print conditions, the shape being designed to enable the detection of a copy modifying the appearance of a plurality of the cells.

This invention concerns methods and devices for securing and authenticating documents. It applies in particular to detecting copies of documents, packaging, manufactured items, molded items and cards, e.g. identification cards or bankcards, the term “document” relating to all material carrying an item of information.

A bar code is a visual representation of information on a surface, which can be read by a machine. In the beginning, these bar codes represented the information in the width of the parallel lines and the width of the spaces between the lines, which limited the quantity of information per surface unit. These bar codes are, as a result, called one-dimensional, or “1D”, bar codes. To increase this quantity of information, the bar codes have evolved towards patterns of concentric circles or dots.

The bar codes are widely used for carrying out a rapid and reliable automatic identification capture with a view to automatic processing.

The bar codes can be read by portable optical readers or scanners equipped with adapted software.

Two-dimensional matrix bar codes, called 2D bar codes, are data carriers that are generally constituted of square elements arranged in a defined perimeter, each element or cell taking one of two pre-defined colors (for example black and white), according to the value of the binary symbol described in that cell. Also, a 2D bar code makes it possible to represent, for the same surface area, a much larger quantity of information than a one-dimensional bar code.

Therefore the 2D bar code is often preferred to the one-dimensional bar code, even though its reading systems are more complex and more costly and allow reading that is generally less flexible, with regard to the respective position of the reader and the bar code.

These 2D bar codes are widely used for storing or transmitting information on passive objects, for example paper, identity cards, stickers, metal, glass or plastic.

A system creating 2D bar codes receives information, as input, generally a sequence of symbols of a pre-defined alphabet, for example the 128-character ascii alphabet or the 36-symbol alphanumeric alphabet or a binary alphabet.

On output, this system provides a digital image, which is then printed on an object that is called, according to this invention, a “document”. An image acquisition system connected to a processing unit is generally used for reading the bar code and reconstructing the information contained in the 2D bar code.

A bar code, whether 1D or 2D, is used to transmit information from an emitter to a receiver. For a large number of applications, this method of transmitting information must be performed in a secure way, which entails in particular that (1) the message remains confidential (you do not want it to be read by third-parties), (2) that the message can be authenticated (you want to make sure of its provenance), (3) that the integrity of the message can be verified (you want to make sure that the message has not been modified or forged), (4) and that the message cannot be repudiated by the emitter (you want to avoid the situation in which the author of a message denies having sent it). These different levels of security can be achieved by encrypting, or enciphering, the message, with an encryption key known only by people or entities authorized to read or write the messages. Private-key and public-key cryptographic methods are generally combined, if you want to achieve several of the security properties mentioned above.

With the encryption of the message, a 2D bar code allows a physical document to be given security properties that were initially designed for messages and documents of a digital nature. Thus, a 2D bar code can help to avoid or detect the forgery of documents. For example, if textual information printed uncoded on the document is altered, for example the document's expiry or use-by date, or an identity card's personal data, the same data encrypted in the 2D bar code cannot by easily altered in conjunction with the alteration of the textual information and the 2D bar code therefore makes it possible to detect the alteration of the textual information.

A 2D bar code can also be used for document traceability and tracking. The document's source, destination and/or distribution route can be encrypted in the 2D bar code printed on that document and make it possible to check whether the document is in a legitimate location of the distribution route. The encryption of this information is essential in this case, since otherwise it may be falsified or even bear no relationship to the original information.

Thanks to the use of bar codes, digital cryptographic methods can be applied to analog (of the real world) and passive (not able to react to a signal) documents, thus giving these documents security properties equivalent to the security properties of digital information or documents.

However, the 2D bar codes offer no protection against identical copying, known as “slavish” copying. Each cell of the 2D bar code can normally be identified and read with great precision and an identical copy of each bar code can, as a result, be perfectly made without difficulty. Thus, the basic issue of authenticating the source (the origin) of the document cannot be fully processed: an encrypted 2D bar code does not make it possible to say whether the document that contains it is an original or a reproduction of the original document.

Also, the owners of intellectual property rights, in particular trade marks, and the organizations that generate official documents and that have adopted encrypted 2D bar codes or other data carriers, such as RFID (acronym for “Radio Frequency Identification”) electronic tags, to help them solve their forgery problems, must nevertheless use radically different authentication methods (“authenticators”), such as holograms, security inks, microtexts, or so-called “guilloche” patterns (fine curved lines interfering with digital reproduction systems, for example through a watermark effect), to avoid or detect slavish counterfeiting.

Nevertheless these means have their limits, which become more and more obvious with the daily increasingly rapid distribution of technology, allowing counterfeiters to copy these authenticators better and better in less and less time. Thus, holograms are copied better and better by the counterfeiters and the end-users have neither the capabilities nor the motivation to check these holograms. Security inks, so-called “guilloche” patterns and microtexts are not cost-effective, are difficult to insert into companies' production lines or information channels and do not offer the level of security generally required. In addition, they can be difficult to identify and do not offer real guarantees of security against determined counterfeiters.

When possible, the information read is used in combination with a database to determine a document's authenticity. Thus you can, for example, indirectly detect a counterfeit, if another document bearing the same information has been detected previously, or in a different place. Note that it is assumed in this case that each document bears a unique item of information, which is not always possible with all the document production means, especially offset printing. However, implementing this type of solution is costly and rapid access to the database may not be possible, especially when the reading system is portable. Lastly, even access to a database does not solve the problem of knowing which of two apparently identical documents is counterfeit.

Copy detection patterns are a type of visible authentication patterns, which generally appear to be noise and are generated from a key in a pseudo-random way. These copy detection patterns are basically used to distinguish original printed documents and printed documents copied from the former, for example by photocopying or using a scanner and a printer. This technique operates by comparing a captured image of an analog, i.e. real-world, copy detection pattern with an original digital representation of this pattern to measure the degree of difference between the two of them. The underlying principle is that the degree of difference is higher for the captured image of a pattern that has not been produced from an original analog pattern, as a result of degradation during copying.

To carry information, a pseudo-random image is cut into blocks and the colors are inverted for the pixels of each block representing one of the binary values, leaving unchanged the pixels of each block representing the other binary value. Other binary value block encoding can also be used. In practice, the blocks must be large enough for the reading of the binary value to be reliable and, as a result, the quantity of information carried by the image is limited.

This technique has drawbacks however. In particular, it is optimized for detecting copies but does not allow a large quantity of information to be carried for a given surface area; however, many applications entail documents carrying a large amount of secured information while major constraints (esthetics, available space, trade mark image, etc) limit the surface area available for detecting copies. The utilization of this technique requiring a comparison of two images and a scaling, costly in number of calculations, turns out to be necessary for the captured pattern. This scaling can also lead to a degradation of the modified image, which can in certain circumstances have the effect of limiting the detectability of copies. In addition, the reader must regenerate and store the copy detection pattern in memory during the image comparison phase, which is an operation that is both costly and potentially dangerous, since a wrongdoer may be able to “read” the memory, which may allow them to identically reproduce the copy detection pattern.

The present invention aims to remedy the drawbacks of both the 2D bar codes and the copy detection patterns. In particular, an aim of the present invention is to provide the means and the steps for producing an information matrix that enables the detection of copies or counterfeit documents.

To this end, according to a first aspect, the present invention envisages a method for securing a document, characterized in that it comprises:
a step of determining print conditions of said document;
a step of determining physical characteristics of cells of at least one shape, according to the print conditions, such that the proportion of cells printed with a print error coming solely from unanticipated unknowns in printing is greater than a pre-defined first value and less than a pre-defined second value;
a step of representing an item of information by varying the appearance of cells presenting said physical characteristics and
a step of printing said shape utilizing said print conditions, said shape being designed to enable the detection of a copy modifying the appearance of a plurality of said cells.

“Print error” refers here to a modification in a cell's appearance that modifies the interpretation of the information borne by this cell, during an analysis free from reading or capture errors, for example, microscopic. It is noted that if the cells often originally have binary values, the captured values are frequently in grey-scale and therefore there is a non-binary value associated to a cell; this latter can, for example, be interpreted as a probability of the cell's original binary value.

In effect, the inventors have discovered that, when the proportion of print errors is above a pre-defined value, copying the shape by utilizing the same print means as the original print, or analog means, necessarily causes an additional proportion of errors making this copy detectable.

The inventors have also discovered that, depending on given constraints (such as a constraint concerning the SIM's number of cells or physical size), there is an optimum proportion of print errors in terms of ability to detect copies. This optimum proportion of print errors corresponds to a given cell size or print resolution, a function of the print means.

Thus, contrary to what might be assumed, the highest print resolution is not necessarily, and is even rarely, a resolution giving the best result in terms of ability to detect copies.

In this case, the native print resolution of the print means needs to be differentiated from the print resolution of the cells, each of which is, generally, made up of a plurality of ink dots, each ink dot corresponding to the native print resolution. Expressly, a SIM's print resolution cannot be varied. In effect, most print means print in binary (presence or absence of an ink dot) with a fixed resolution, and the grey or color levels are simulated by the various screening techniques. In the case of offset printing, this “native” resolution is determined by the plate's resolution, which is, for example, 2,400 dots/inch (2,400 dpi). Thus, a grey-scale image to be printed at 300 pixels/inch (300 dpi) may in reality be printed in binary at 2,400 dpi, each pixel corresponding approximately to 8×8 raster dots.

While the print resolution cannot, generally, be varied, on the other hand the size in pixels of the SIM's cells can be varied, in such a way that one cell is represented by several print dots. Thus, you can for example represent a cell by a square block of 1×1, 2×2, 3×3, 4×4 or 5×5 pixels (non-square blocks are also possible), corresponding respectively to resolutions of 2,400, 1,200, 800, 600 and 480 cells/inch.

According to particular features, during the step determining the physical characteristics of cells, the dimension of the cells to be printed is determined.

According to particular features, during the step determining the physical characteristics of cells, a sub-section of the cells is determined, a sub-section that has a uniform and variable color for representing different values of an item of information, said sub-section being strictly less than said cell.

According to particular features, the pre-defined first value is greater than 5%.

According to particular features, the pre-defined first value is greater than 10%.

According to particular features, the pre-defined first value is greater than 15%.

According to particular features, the pre-defined first value is greater than 20%.

According to particular features, the pre-defined second value is less than 25%.

According to particular features, the pre-defined second value is less than 30%.

According to particular features, during the print step, the native resolution of the print means performing said print is utilized.

According to particular features, the document securization method as described in brief above comprises, in addition, a step of generating the shape in a digital information matrix representing a message comprising redundancies.

In effect, the inventor has discovered that any copy or print of an item of matrix information printed sufficiently small presents an error quantity that increases with the fineness of the print and that inserting redundancies, for example error-correcting codes, in the matrix information makes it possible to determine whether this is a copy or an original:

inserting redundancies allows the message to be read over a noisy channel and/or the error quantity of the encrypted message to be measured, and thus making it possible to determine whether this is a copy or an original.

It is noted that the degradations due to printing or copying are dependent on many factors, such as the quality of the print, the carrier and the image resolution utilized during the image capture or marking step carried out to produce a copy.

According to particular features, during the step generating the shape, there is a sufficient proportion of redundancies to allow an error proportion greater than said pre-defined first value to be corrected.

According to particular features, during the generation step, said redundancies comprise error-correcting codes.

Thanks to these provisions, the content of the mark makes it possible to correct errors due to the marking step and to retrieve the original message.

According to particular features, during the generation step, said redundancies comprise error-detecting codes.

Thanks to each of these provisions, the numbers of errors affecting the mark can be determined and used as the basis for detecting a copy of said mark.

According to particular features, during the step of generating an information matrix, said information matrix represents, at the level of each elementary cell and independent of the neighboring elementary cells, the message comprising the redundancies.

In this way, the quantity of information carried by the mark is increased with respect to the representation of values by blocks of dots.

According to particular features, during the marking step at least five per cent of unconnected errors are generated and the utilization of redundancies allows said unconnected errors to be counted.

In effect, the inventor has discovered that a high error rate from the marking step was easier to utilize for distinguishing a copy from the mark, a copy whose error rate is a function of the initial mark's error rate.

According to particular features, during the step generating the information matrix, the redundancies are designed to allow the detection of unconnected marking errors in the mark produced during the marking step.

According to particular features, during the marking step a robust additional mark bearing a message is added to the information matrix mark.

Thanks to these provisions, the message borne by the additional mark is more robust to degradations caused by copying and can therefore be read even when these degradations are significant, for example after several successive copies.

According to particular features, during the step of generating the information matrix a representation of said message is encrypted with an encryption key.

According to particular features, during the step of generating the information matrix a representation of said message is encoded for generating said redundancies.

According to particular features, during the step of generating the information matrix a representation of said message is replicated to form several identical copies.

In this way redundancies, allowing errors to be detected when the mark is read, are created very simply.

According to particular features, during the step of generating the information matrix the positions of elements of the representation of said message are swapped according to a secret key.

According to particular features, during the step of generating the information matrix the positions of elements of the representation of said message are partially swapped according to a secret key that is different to the first swap's secret key.

According to particular features, during the step of generating the information matrix a value substitution function, which is dependent, on the one hand, on the value of the element and, on the other hand, on the value of an element of a secret key, is applied, to at least one part of the elements of a representation of said message.

According to particular features, during the step of generating the information matrix a partial value substitution function, which is dependent, on the one hand, on the value of the element and, on the other hand, on the value of an element of a secret key that is different to the first substitution function's secret key, is applied, to at least one part of the elements of a representation of said message.

According to particular features, said substitution function substitutes the values by pairs associated to neighboring cells in said shape.

Thanks to each of these provisions, the message is provided with security features against reading by an unauthorized third-party.

According to particular features, during the step of generating the information matrix at least one key is utilized such that the associated key needed to retrieve the message is different.

In this way, the key used to determine the authenticity of the document or product having a mark representing said information matrix cannot be used to generate another information matrix containing a different message.

According to particular features, during the step of generating the information matrix, a digital information matrix is generated representing at least two messages provided with different means of security.

Thanks to these provisions, different people or computer systems can have different authorizations and means of reading, for example in order to separate the authentication functions and the functions determining the origin of counterfeit products.

According to particular features, one of said messages represents information required, on reading the information matrix, to determine the other message and/or detect the other message's errors.

According to particular features, one of said messages represents at least one key required to read the other message.

According to particular features, during the step of generating the information matrix a hash of said message is added to a representation of the message.

According to a second aspect, the present invention envisages a device for securing a document, characterized in that it comprises:
a means of determining print conditions of said document;
a means of determining physical characteristics of cells of at least one shape, according to the print conditions, such that the proportion of cells printed with a print error coming solely from unanticipated unknowns in printing is greater than a pre-defined first value and less than a pre-defined second value;
a means of representing an item of information by varying the appearance of cells presenting said physical characteristics and
a means of printing said shape by utilizing said print conditions, said shape being designed to enable the detection of a copy modifying the appearance of a plurality of said cells.

As the advantages, aims and special features of this device that is the subject of the second aspect of the present invention are similar to those of the method that is the subject of first aspect of the present invention they are not repeated here.

According to a third aspect, the present invention envisages a computer program comprising instructions that can be read by a computer and implementing the method as described in brief above.

According to a fourth aspect, the present invention envisages a data carrier that can be read by a computer and comprising instructions that can be read by a computer and implementing the method as described in brief above.

The present invention also concerns a method and a device for securing documents and products based on improved secured information matrices. It applies in particular to the identification and authentication of documents and products. The invention applies in particular to uniquely identifying, authenticating originals and detecting copies of documents, packaging, manufactured items, molded items and cards, e.g. identification cards or bankcards.

There are many ways of protecting a document, either by means that are costly (hologram, security ink, etc) since they require consumables, or by digital means that are, in general, more economical. The digital means offer the additional advantage of being well suited to the digital processing of data, and thus detectors can be used that are not very costly, generally comprising a processor connected to a tool for capturing images or signals (scanner, etc) and an interface with an operator.

For securing a document by digital means, you can turn to the use of digital authentication codes (“DAC”). For example, you can print a secured information matrix (“SIM”) or a copy detection pattern (“CDP”) on it. The digital authentication codes also enable encrypted information to be contained and thus for documents or products to be tracked.

A DAC is a digital image that, once printed on a document, both allows it to be tracked and at the same time allows any copy of the latter to be detected. Unlike a 2D bar code, which is a mere container of information that can be identically copied, any copy of a DAC entails a degradation of the latter. This degradation can be measured by computer means from a captured image and allows the reader to determine whether the DAC is an original or a copy. Moreover, the information contained in a DAC is generally encrypted and/or scrambled.

The DACs can be invisible or at least difficult to see, for example a digital watermark vulnerable to copying integrated to the image, or a pseudo-randomly arranged dot pattern, also known as an “AMSM”. This type of DAC is typically distributed over a large surface area and is not very dense in information. It can also be dense in information and concentrated in a small surface area, for example SIMs and CDPs. Often the SIMs and CDPs are integrated in the digital file of the document or product, and printed at the same time as the latter.

CDPs are noisy patterns generated pseudo-randomly from a cryptographic key and copies are determined by comparing and measuring the similarity between the original digital image and the captured image. A CDP can also contain a small quantity of information.

SIMs are information matrices designed to contain a large quantity of information in an encrypted way, this information being robust to high error rates during reading. Copies are determined by measuring the message's error rate.

SIMs and CDPs are often constituted half of “black” (or color) pixels and half of “white”, or unprinted, pixels. However, for certain types of print, or certain types of papers, or for certain settings of the printing machine, the printed SIM can be overinked. Yet excessive inking of the SIM can significantly reduce its readability, and even its ability to be distinguished from one of its copies. It is therefore extremely desirable to avoid this excessive inking, but this is not always easy in practice since the level of inking is rarely a datum fully controlled by the printer; in certain cases it is even a datum imposed on them by the client. It would therefore be very advantageous to have SIMs whose properties are less sensitive to the amount of ink applied to the paper.

It turns out that the SIMs are generally more sensitive to a high level of inking than a low level of inking. In effect, when the level of inking is low, the black cells (or the cells containing color) are generally always printed, and thus reading the matrix is not much affected by this. When the level of inking is too high the ink tends to saturate the substrate, and the white areas are to some extent “flooded” by the ink from the surrounding black areas. A similar effect can be observed for marking by means of contact, laser engraving, etc.

SIMs are, in theory, designed according to a print at a given resolution, for example 600 ppi (points per inch). However, it turns out that, depending on the print context, the optimum print resolution, namely the resolution enabling the best differentiation between originals and copies, varies: the higher the print quality, the greater the SIM print resolution required or, in the same way, the smaller the size of the cells of the SIMs.

The fifth and sixth aspect of the present invention aim to remedy these inconveniences.

To this end, according to a fifth aspect, the present invention envisages a method for securing a document comprising a step of printing a shape comprised of cells representing an item of information, the appearance of each cell being variable according to the information represented by said cell, said shape being designed to enable the detection of a copy modifying the appearance of a plurality of said cells, characterized in that it comprises:
a step of determining a sub-section of the cells, a sub-section that has a uniform and variable color for representing different values of an item of information, said sub-section being strictly less than said cell and
a step of representing, in said shape, an item of information by varying the appearance of sub-sections of cells.

Thanks to these provisions, even if, during printing, there is a high level of inking, insofar as only a restricted part of the cell is inked, the risk of the cells' ink spreading over another cell and changing its appearance is reduced and the ability to detect a copy is improved.

Thus, in order to make sure that the SIMs can detect copies whatever the print conditions, a SIM is utilized in which at least one part is designed for print conditions where the level of inking is too great. Therefore the SIM's anti-copy properties are not very sensitive to the level of inking used in printing.

It is noted that the choice of sub-section to be printed in each cell is for preference tied to the choice of the dimension of the cells, described elsewhere, so as to obtain an error proportion favoring the detection of copies.

According to particular features, the method as described in brief above comprises a step of defining several shapes, not superimposed, the dimensions of the cells of at least two different shapes being different.

Thanks to these provisions, the same SIM can be printed on different types of carrier or with different print means not having the same resolution and, nonetheless, preserve its copy detection properties.

According to particular features, the method as described in brief above comprises a step of determining several shapes, not superimposed, and, during the step of determining a sub-section, said sub-section is different for at least two different shapes.

Thanks to these provisions, SIMs are obtained that are robust to a wide range of levels of inking since several portions of this SIM, portions corresponding to the shapes described above, are adapted to different levels of inking. A SIM can thus contain several areas where the densities of the cells, i.e. the ratios of the sub-section's surface area to the cell's surface area, vary, such that at least one of the densities is suitable with respect to the level of inking used for printing. In this case, the reading can be performed by favoring the areas having the most suitable level of inking.

According to particular features, each cell is square and said sub-section of the cell is also square.

For example, if the cell is 4×4 pixels, you can choose to print a square sub-section of 3×3 pixels, or 2×2 pixels. The inking is therefore reduced respectively by a ratio of 9/16 and 1/4 (it is noted that the white cells are not affected). To take another example, if the cell is 3×3 pixels a square sub-section of 2×2 or 1×1 pixels can be printed.

According to particular features, said sub-section is cross-shaped. For example, this cross is formed of five pixels printed out of nine.

According to particular features, the method that is the subject of the present invention, as described in brief above, comprises a step of determining dimensions of the cells to be printed of at least one shape, according to the print conditions, such that the proportion of cells printed with a print error coming solely from unanticipated unknowns in printing is greater than a pre-defined first value and less than a pre-defined second value.

As the particular features of the method that is the subject of the first aspect of the present invention are also the particular features of the method that is the subject of the fifth aspect of the present invention they are not repeated here.

According to a sixth aspect, the present invention envisages a printed shape comprised of cells representing an item of information, the appearance of each cell being variable according to the information represented by said cell, said shape being designed to enable the detection of a copy modifying the appearance of a plurality of said cells, characterized in that the cells comprise a sub-section that has a uniform and variable color for representing different values of an item of information, said sub-section being strictly less than said cell, the appearance of the sub-sections of cells representing said information.

According to a seventh aspect, the present invention envisages a device for securing a document comprising a means of printing a shape comprised of cells representing an item of information, the appearance of each cell being variable according to the information represented by said cell, said shape being designed to enable the detection of a copy modifying the appearance of a plurality of said cells, characterized in that it comprises:
a means of determining a sub-section of the cells, a sub-section that has a uniform and variable color for representing different values of an item of information, said sub-section being strictly less than said cell and
a means of representing an item of information by varying the appearance of sub-sections of cells.

As the advantages, aims and special features of this printed shape that is the subject of the sixth aspect of the present invention and of the device that is the subject of the seventh aspect of the present invention are similar to those of the method that is the subject of the fifth aspect of the present invention they are not repeated here.

In order to make a decision concerning the authenticity of a document according to errors borne by the cells of a shape, you can decode the message borne by the shape or reconstitute the image of said shape. Nevertheless, in the second case, it is necessary to provide, in the copy detection device, a means of restoring the original digital shape, which represents a grave security weakness since a counterfeiter who has got hold of this device can therefore generate original shapes without error. In the first case, if the marking has significantly degraded the message (which is especially the case with copies), or if a large quantity of information is carried, the message might not be readable, in which case an error rate cannot be measured. In addition, the reading of the message borne by the shape by the copy detection device again represents a security weakness since a counterfeiter who has got hold of this device may use this message.

In addition, the determination of the shape's authenticity entails a heavy use of resources of memory, processing and/or communications with a remote authentication server.

The eighth aspect of the present invention aims to remedy these inconveniences.

To this end, according to its eighth aspect, the present invention envisages a method for determining the authenticity of a shape printed on a document, characterized in that it comprises:
a step of determining pluralities of cells of said printed shape, the cells of each plurality of cells corresponding to the same item of information,
a step of capturing an image of said shape,
for each plurality of cells of said shape, a step of determining a proportion of cells of said plurality of cells that do not represent the same information value as the other cells of said plurality of cells and
a step of determining the authenticity of said shape according to said proportion for at least a said plurality of cells.

Thus, thanks to the utilization of the eighth aspect of the present invention, it is not necessary to reconstitute the original replicated message, nor even to decode the message and it is not necessary for there to be a signifying message, the information able to be random. In effect, a message's error quantity is measured by exploiting certain properties of the message itself, at the time of the encoded message's estimation.

It is noted that it is, however, necessary to know the groupings of cells that represent the information value, generally binary.

According to particular features, during the step determining the proportion, an average value is determined for the information borne by the various cells of the same plurality of cells.

According to particular features, during the step determining the proportion, said average is determined by weighting the information value borne by each cell according to said cell's appearance.

Thus, a weight, or coefficient, is associated indicating the probability that each estimated bit of the encoded message is correctly estimated. This weight is used for weighting the contributions of each cell according to the probability that the associated bit is correctly estimated. A simple way of implementing this approach consists of not binarizing the values read in each cell of a plurality of cells.

According to particular features, the method as described in brief above comprises a step of determining the average value, for the whole shape, of the values represented by the cells and a step of compensating for the difference between said average value and an expected average value.

It is noted that the noisier the message is, the higher the risk that the estimated bit of the encoded message is erroneous. This gives rise to a bias such that the measurement of the error quantity under-estimates the actual error quantity. This bias is estimated statistically and corrected when the error quantity is measured.

According to particular features, during the step determining a proportion of the cells of said plurality of cells that do not represent the same information value as the other cells of said plurality of cells, a cryptographic key is utilized modifying the information value represented by at least one cell of the image of the shape to provide the information value of said cell.

According to particular features, during the step determining a proportion of cells of said plurality of cells that do not represent the same information value as the other cells of said plurality of cells, a probability of the presence of a value of an image dot for at least one dot of the image of the shape is utilized.

The reading of a DAC requires the latter to be precisely positioned in the image captured, so that the value of each of the cells it comprises is reconstructed with the greatest possible fidelity taking into account the signal degradations caused by the printing and possibly by the capture. However, the captured images often contain symbols that can interfere with the positioning step.

Locating a SIM can be made more difficult by the capture conditions (poor lighting, blurring, etc), and also by the arbitrary orientation of position over 360 degrees.

Unlike other 2D bar code types of symbols, which vary relatively little with various types of printing, the DAC's characteristics (for example texture) are extremely variable. Thus the prior state of the art methods, such as those presented in U.S. Pat. No. 6,775,409, are not applicable. In effect, this latter method is based on the directionality of the luminance gradient, i.e. its variation according to the direction of its determination, for detecting codes. However, for SIMs the gradient has no particular direction.

Certain methods of locating DACs can benefit from the fact that these latter appear in square or rectangular shapes, which gives rise to a marked contrast over continuous segments, which can be detected and used by standard image processing methods. However, in certain cases these methods are unsuccessful and, secondly, you want to be able to use DACs that are not necessarily (or are not necessarily inscribed in) a square or rectangle

In a general way, a DAC's printed surface area contains a high ink density. However, while exploiting the measurement of ink density is useful, it cannot be the only criterion: in effect, Datamatrixes (registered trademark) or other bar codes that can be adjacent to the DACs have an even higher ink density. This single criterion is not, therefore, sufficient.

Exploiting the high entropy of CDPs, in order to determine the portions of images belonging to CDPs, has been suggested, in patent EP 1 801 692. However, while CDCs, before printing, have an entropy that is indeed high, this entropy can be greatly altered by printing, capture and by the calculation method used. For example, a simple measurement of entropy based on the histogram spread of the pixel values of each area can sometimes lead to higher indicators over regions not very rich in content, which, in theory, should have a low entropy: this can be due, for example, to JPEG compression artifacts, or to the texture of the paper that is represented in the captured image, or to reflection effects on the substrate. Therefore, clearly the entropy criterion is insufficient as well.

More generally, the methods for measuring or characterizing textures appear more appropriate, so as to characterize, at the same time, the intensity properties or the spatial relationships specific to the textures of the DACs. For example, in “Statistical and structural approaches to texture” Haralick describes many texture characterization measurements, which can be combined so as to uniquely describe a large number of textures.

However, the DACs can have textures that vary widely depending on the type of printing or capture, and in general it is not possible or, at least, not very practical to provide the texture characteristics to the DAC location module, all the more so because these must be adjusted depending on effects specific to the capture tool on the texture measurements.

The ninth aspect of the present invention aims to remedy these inconveniences.

To this end, according to its ninth aspect, the present invention envisages a method for determining the position of a shape, characterized in that it comprises:
a step of dividing an image of the shape into areas in such a way that the surface area of the shape corresponds to a number of areas greater than a pre-defined value;
a step of measuring, for each area, a texture indicator;
a step of determining a detection threshold of a part of the shape;
a step of determining areas belonging to said shape by comparing the texture indicator of an area and the corresponding detection threshold;
a step of determining continuous clusters of areas belonging to said shape;
a step of determining the contour of at least one cluster and
a step of matching the contour of at least one cluster with the contour of said shape.

Thus, the present invention utilizes a multiplicity of criteria for locating a shape in a reliable way.

According to particular features, the texture indicator is representative of the density of ink for printing the shape.

According to particular features, the texture indicator is representative of the local dynamic. It is noted that the local dynamic can cover various physical dimensions such as the frequency or rate of local variation, or the sum of the gradients, for example.

According to particular features, during the step determining a detection threshold, said threshold is variable according to the position of the area in the image.

According to particular features, during the step detecting areas belonging to said shape, at least one expansion and/or one erosion is utilized.

According to particular features, said shape is rectangular and, during the matching step, you determine two pairs of dots formed of the farthest apart dots and you determine whether the line segments formed by these pairs present a ratio of lengths falling within a pre-defined range of values.

According to particular features, said shape is rectangular and, during the matching step, you determine two pairs of dots formed of the farthest apart dots and you determine whether the line segments formed by these pairs present an angle falling within a pre-defined range.

According to particular features, said shape is rectangular and, during the matching step, a Hough transform is applied.

According to its tenth aspect, the present invention envisages a device for determining the position of a shape, characterized in that it comprises:
a means of dividing an image of the shape into areas in such a way that the surface area of the shape corresponds to a number of areas greater than a pre-defined value;
a means of measuring, for each area, a texture indicator;
a means of determining a detection threshold of a part of the shape;
a means of determining areas belonging to said shape by comparing the texture indicator of an area and the corresponding detection threshold;
a means of determining continuous clusters of areas belonging to said shape;
a means of determining the contour of at least one cluster and
a means of matching the contour of at least one cluster with the contour of said shape.

As the advantages, aims and special features of this device that is the subject of the tenth aspect of the present invention are similar to those of the method that is the subject of ninth aspect of the present invention they are not repeated here.

According to an eleventh aspect, the present invention envisages a method for generating an anti-copy shape, characterized in that it comprises:
a step of determining at least one print characteristic of said shape,
a step of incorporating, in said shape, a message representing said print characteristic and
a step of printing said shape, by utilizing said print characteristic.

In effect, the inventors have discovered that, if they are known, the print characteristics such as the print means, the substrate used, and other print parameters (such as the raster size in offset) can be useful in utilizing the anti-copy shape, especially for authenticating it.

According to particular features, at least one said print characteristic is representative of a type of substrate on which said shape is printed.

For example, you specify whether the substrate is paper, cardboard, aluminum, PVC, glass, etc.

According to particular features, at least one said print characteristic is representative of the print means utilized.

For example, you specify whether the print means operates in offset, typography, screen, gravure printing, etc.

According to particular features, at least one said print characteristic is representative of an inking density utilized during printing.

According to particular features, during the step determining at least one print characteristic, an image is captured of a pattern printed with the print means utilized during the print step and the value of said characteristic is determined automatically, by processing said image.

According to a twelfth aspect, the present invention envisages a method for determining the authenticity of a printed anti-copy shape, characterized in that it comprises:
a step of capturing an image of said printed anti-copy shape,
a step of reading, in said image, an item of information representing at least one print characteristic of said shape and
a step of determining the authenticity of said printed anti-copy shape by utilizing said information representing at least one print characteristic of said shape.

According to a thirteenth aspect, the present invention envisages a device for generating an anti-copy shape, characterized in that it comprises:
a means of determining at least one print characteristic of said shape,
a means of incorporating, in said shape, a message representing said print characteristic and
a means of printing said shape, by utilizing said print characteristic.

According to a fourteenth aspect, the present invention envisages a device for determining the authenticity of a printed anti-copy shape, characterized in that it comprises:
a means of capturing an image of said printed anti-copy shape,
a means of reading, in said image, an item of information representing at least one print characteristic of said shape and
a means of determining the authenticity of said printed anti-copy shape utilizing said information representing at least one print characteristic of said shape.

As the advantages, aims and special features of this method that is the subject of the twelfth aspect of the present invention and of these devices that are the subjects of the thirteenth and fourteenth aspects of the present invention are similar to those of the method that is the subject of the eleventh aspect of the present invention they are not repeated here.

The principal or particular features of each of the aspects of the present invention constitute particular features of the other aspects of the present invention in the aim of constituting a document securization system presenting the advantages of all the aspects of the present invention.

Other advantages, aims and characteristics of the present invention will become apparent from the description that will follow, made, as an example that is in no way limiting, with reference to the drawings included in an appendix, in which:

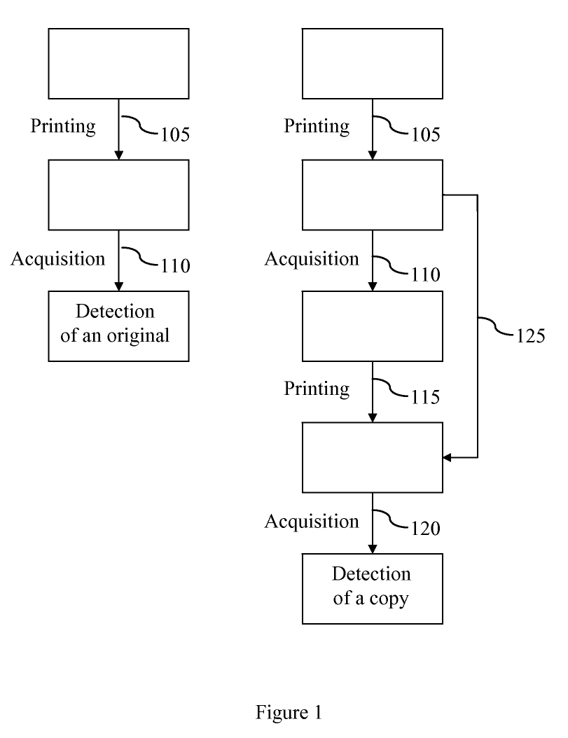

FIG. 1 represents, schematically, in the form of a logical diagram, steps of detecting, printing and acquiring information for an original and for a copy of said original;

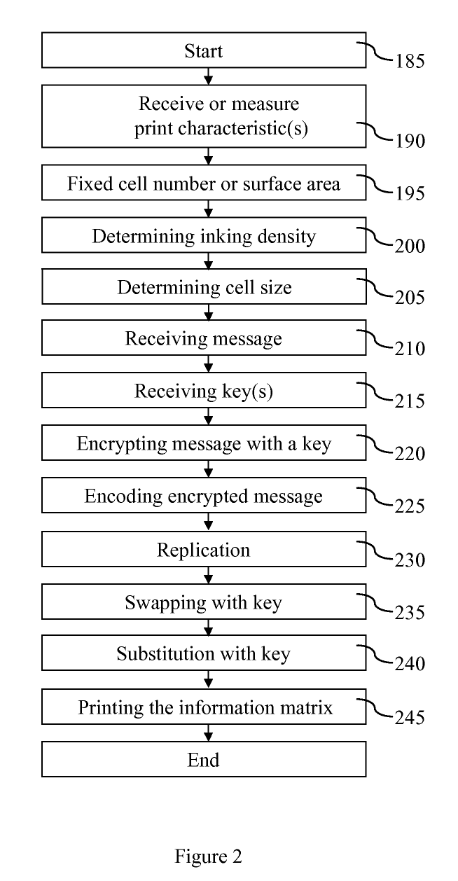

FIG. 2 represents, schematically, in the form of a logical diagram, steps utilized to mark a document or products with a view to being able to authenticate them subsequently,

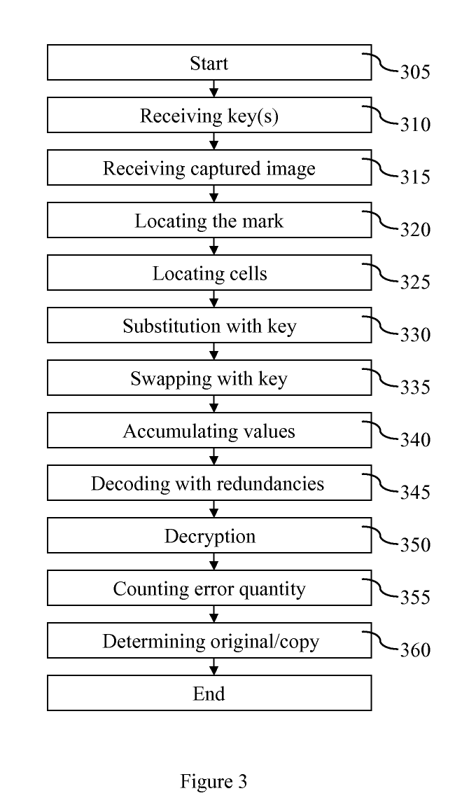

FIG. 3 represents, schematically, in the form of a logical diagram, steps utilized to authenticate a document or products with marking carried out by utilizing the steps illustrated in FIG. 2,

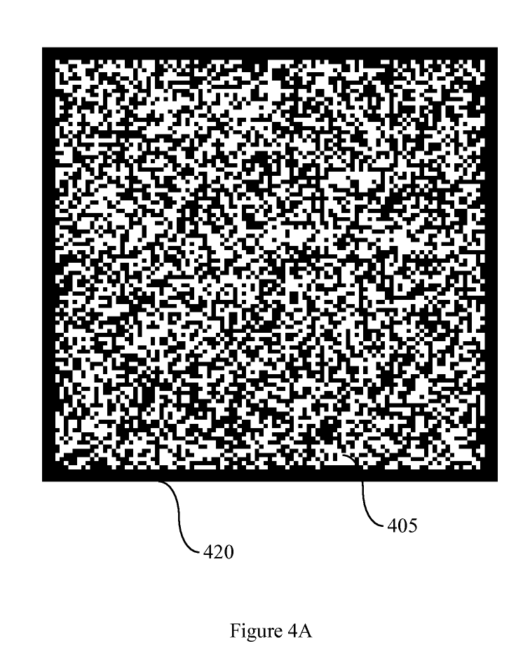

FIGS. 4A and 4B represent information matrices for marking an object,

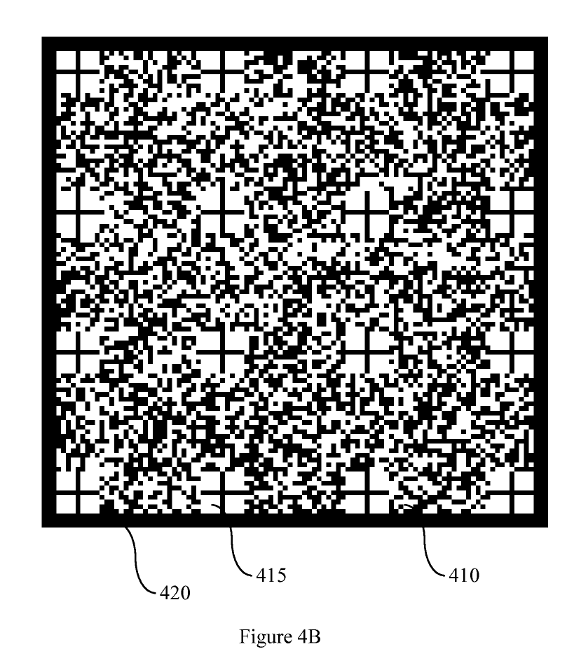

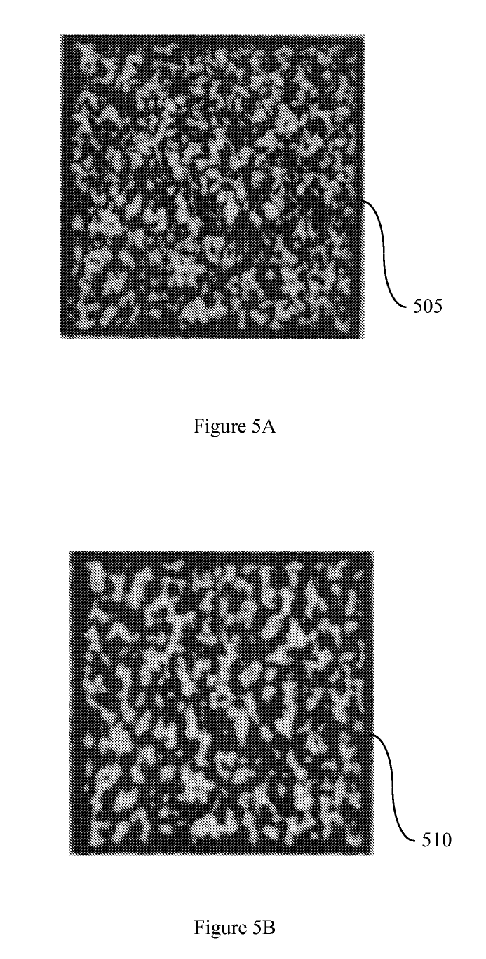

FIGS. 5A and 5B represent, respectively, a captured image of an authentic mark of an information matrix and a recopied mark of said matrix of information,

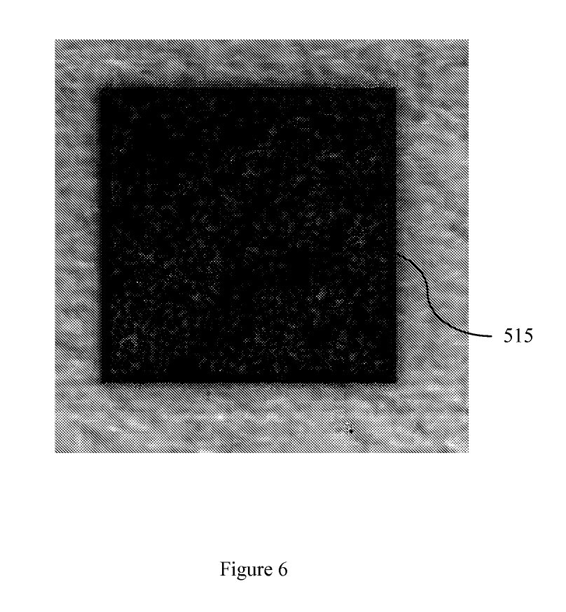

FIG. 6 represents an information matrix printed with too high a level of inking,

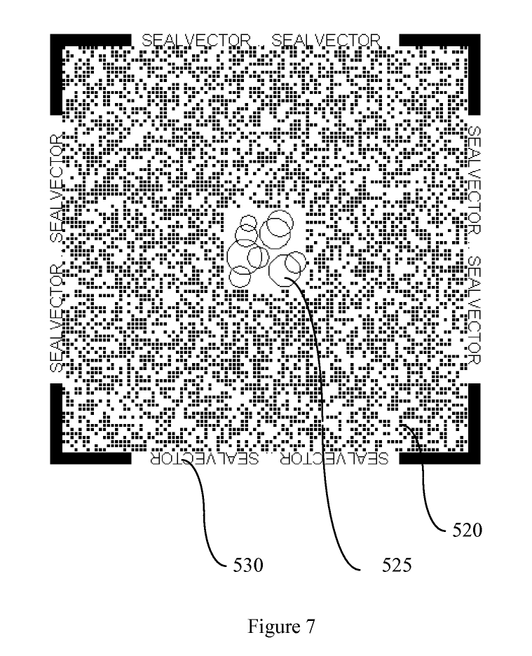

FIG. 7 represents an information matrix comprising, in its central part, a variable characteristic dot matrix,

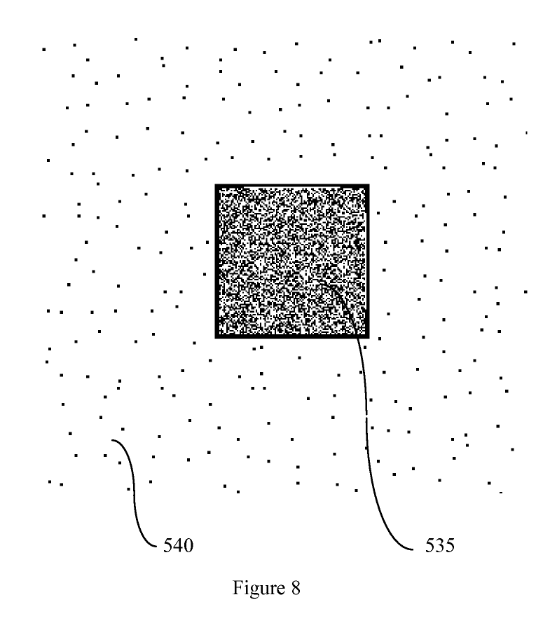

FIG. 8 represents an information matrix surrounded by a variable characteristic dot matrix,

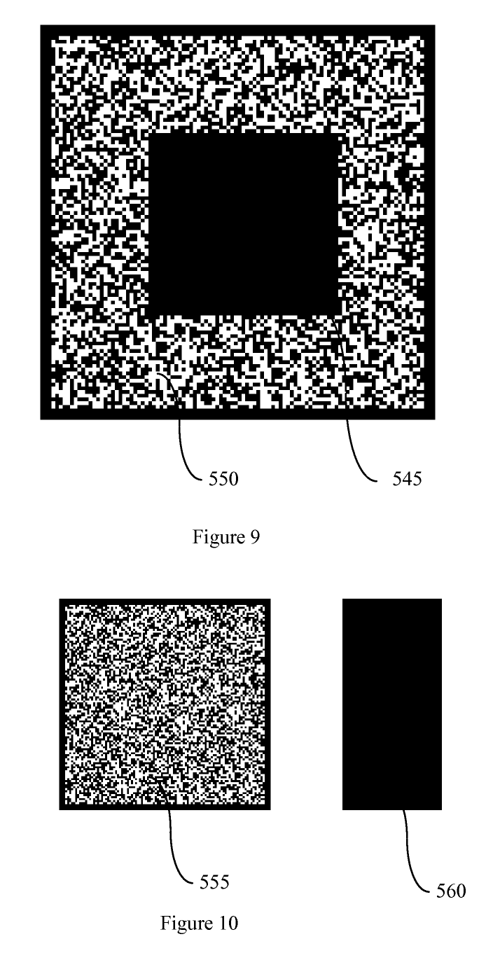

FIG. 9 represents an information matrix comprising a fully inked area,

FIG. 10 represents an information matrix comprising an adjacent inked area,

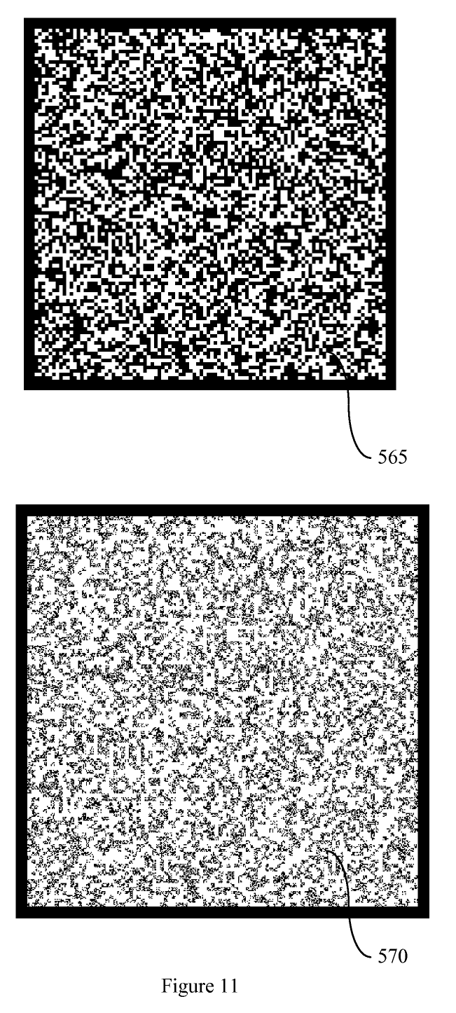

FIG. 11 represents, firstly, on top, an information matrix and, secondly, below, the same information matrix modulated, cell by cell, by a replicated message,

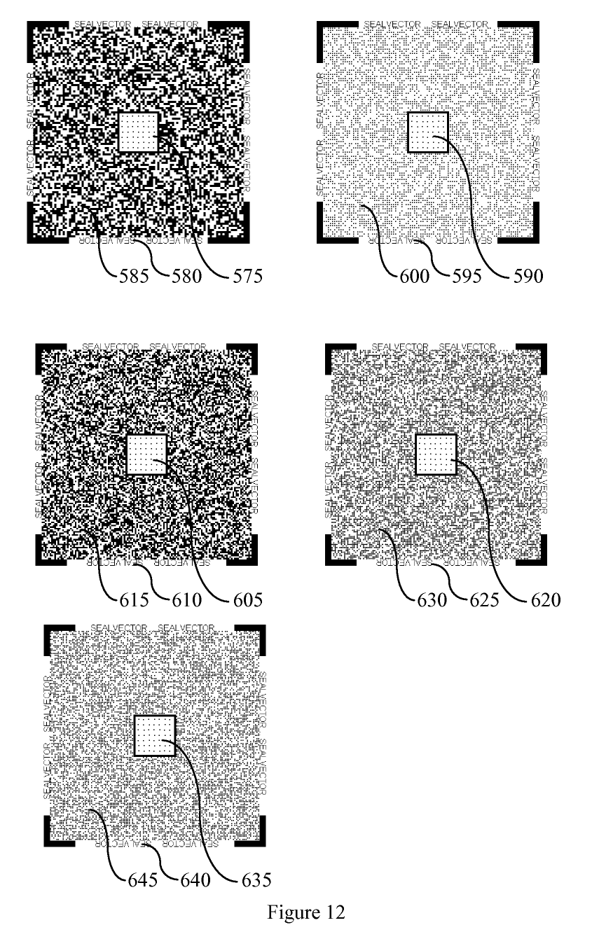

FIG. 12 represents various information matrices in which only the reduced parts of the cells present a variable appearance, black or white,

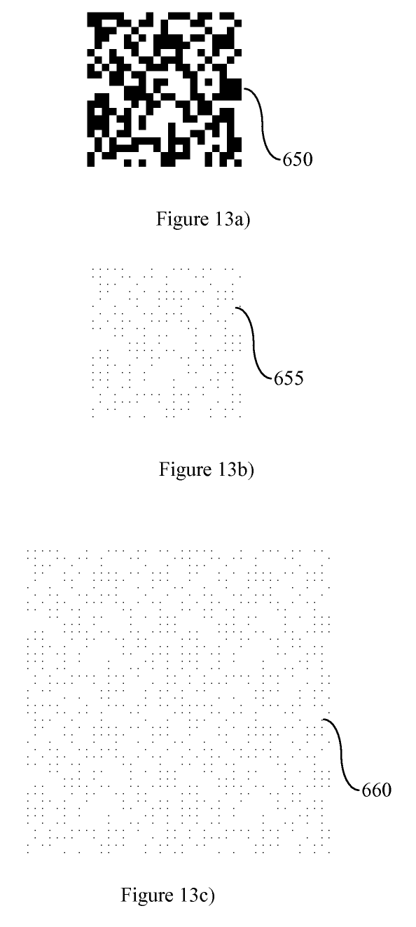

FIG. 13 represents information matrices utilizing different parts of cells with variable appearance and, for the last, a tiling of the second,

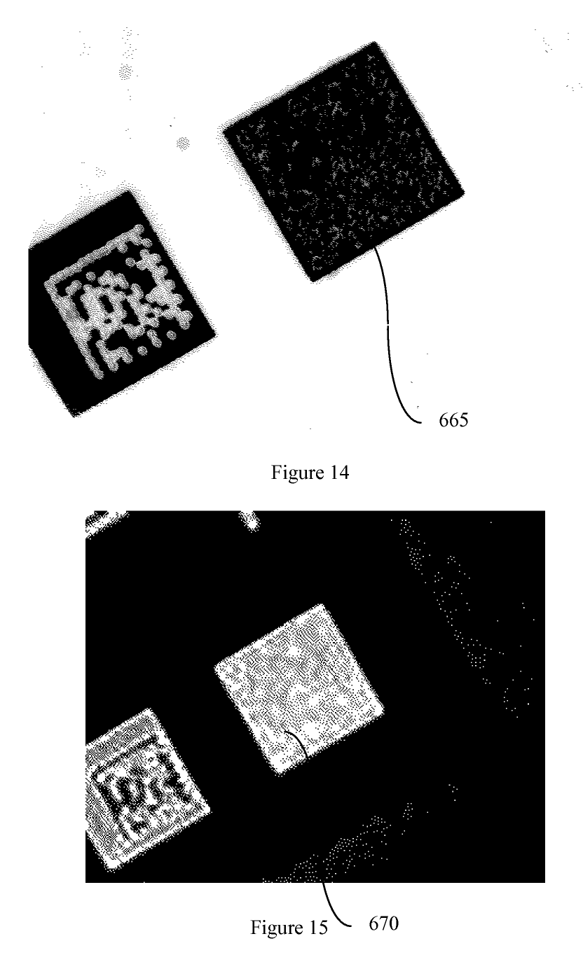

FIG. 14 represents an information matrix captured with an angle of about 30 degrees and a resolution of about 2,000 dpi,

FIG. 15 represents a measurement of a combined texture indicator (106×85) performed on the image from FIG. 14,

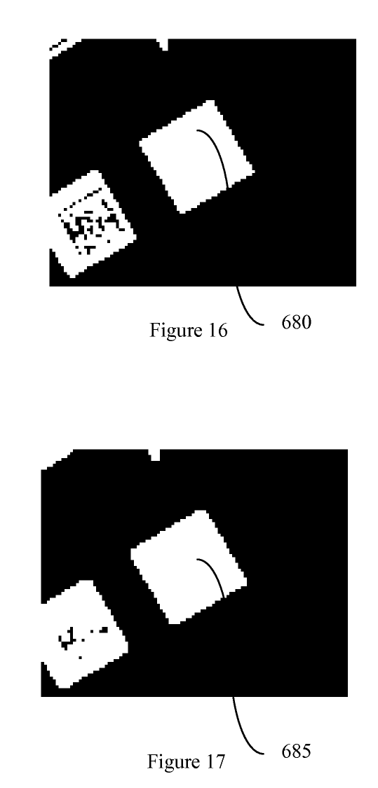

FIG. 16 represents the image from FIG. 15, after thresholding, i.e. after comparison with a threshold value,

FIG. 17 represents the image from FIG. 16 after applying at least one expansion and one erosion,

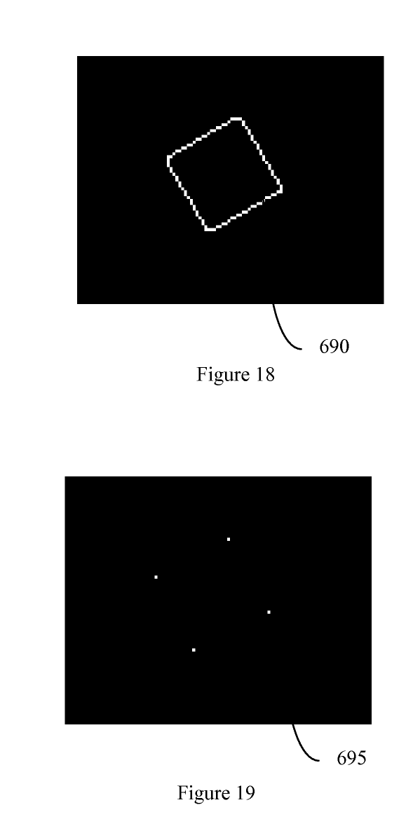

FIG. 18 represents an information matrix contour, a contour determined by processing the image from FIG. 17,

FIG. 19 represents corners of the contour illustrated in FIG. 18, determined by processing the image from FIG. 18 and

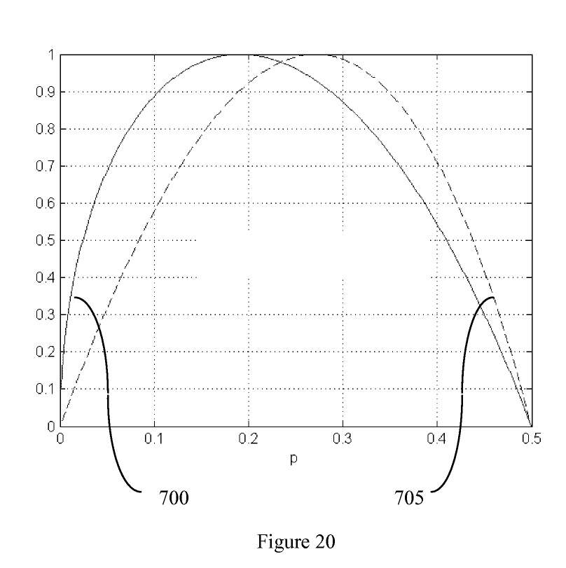

FIG. 20 represents graphs representing error proportions according to the dimensions of an information matrix's cells.

Throughout the description the terms “enciphering” and “encrypting” will be used interchangeably.

Before giving the details of the various particular embodiments of certain aspects of this invention, the definitions that will be used in the description are given below.
“information matrix”: this is a machine-readable physical representation of a message, generally affixed on a solid surface (unlike watermarks or steganographies, which modify the values of the pixels of a design to be printed). The information matrix definition encompasses, for example, 2D bar codes, one-dimensional bar codes and other less intrusive means of representing information, such as “Dataglyphs” (data marking);
“cell”: this is an element of the information matrix that represents a unit of information ;
“document”: this is any (physical) object whatsoever bearing an information matrix;
“marking” or “printing”: any process by which you go from a digital image (including an information matrix, a document, etc) to its representation in the real world, this representation generally being made on a surface: this includes, in a non-exclusive way, ink-jet, laser, offset and thermal printing, and also embossing, laser engraving and hologram generation. More complex processes are also included, such as molding, in which the digital image is first engraved in the mold, then molded on each object (note that a “molded” image can be considered to have three dimensions in the physical world even if its digital representation comprises two dimensions). Note also that several of the processes mentioned include several transformations, for example standard offset printing (unlike “computer-to-plate” offset), including the creation of a film, said film serving to create a plate, said plate being used in printing. Other processes also allow an item of information to be printed in the non-visible domain, either by using frequencies outside the visible spectrum, or by inscribing the information inside the surface, etc. and
“capture”: any process by which a digital representation of the real world is obtained, including the digital representation of a physical document containing an information matrix.

Throughout the description that will follow, shapes that are square overall are utilized. However, the present invention is not restricted to this type of shape but, on the contrary, extends to all shapes that can be printed. For example, shapes constituted of SIMs with different resolutions and different levels of inking, as described above, can be utilized, which would have the advantage, in particular, that at least one SIM corresponds to an optimum resolution and an optimum inking density.

Throughout the description, a filling of the printed shape, which can be represented by a matrix of cells, is utilized. However, the present invention is not restricted to this type of shape but, on the contrary, extends to all filling by cells, of identical or different shapes and sizes.

By way of introduction to the description of particular embodiments of the method and device that are subjects of the present invention, it is noted that the result of the degradation of an information matrix is that certain cells cannot be correctly decoded.

Each step in creating the information matrix is carried out with the aim of the original message being readable without error, even if, and this is a wished-for effect, the initial reading of the information matrix is marred by errors. In particular, one of the aims of this information matrix creation is to use the number or rate of errors of encoded, replicated, swapped or scrambled messages in order to determine the authenticity of a mark of the information matrix and therefore of the document that bears it.

In effect, the rate of this degradation can be adjusted according to print characteristics, such that the production of a copy gives rise to additional errors, resulting in an error rate that is, on average, higher when a copy is read than when an original is read.

In order to understand why measuring the message's error rate can be sufficient to determine whether a document is an original or a copy, an analogy with communications systems can be useful. In effect, the passage of the encoded, scrambled message to the information matrix that represents it is none other than a modulation of the message, this modulation being defined as the process by which the message is transformed from its original form into a form suitable for transmission over a channel. This communications channel, namely the information transmission medium that links the source to the recipient and allows the message to be transported, differs depending on whether the captured information matrix is a captured original information matrix or a captured copied information matrix. The communications channel can vary: thus the “communications channel of an original” and the “communications channel of a copy” are differentiated. This difference can be measured in terms of the signal/noise ratio, this ratio being lower for a captured copied information matrix.

The coded message extracted from a captured copied information matrix will have more errors than the coded message extracted from a captured original information matrix. The number or rate of errors detected is, in accordance with certain aspects of the present invention, used to distinguish a copy from an original.

The communications channel of an original and the communications channel of a copy are described advantageously in terms of the sub-channels comprising them, these differing in part in the two cases. In the following account, each sub-channel of the transmission channel of the signal, i.e. of the information matrix, is an analog-to-digital or digital-to-analog transformation.

FIG. 1 shows the communications channel for a captured original information matrix and for a captured copied information matrix. The first channel comprises a sub-channel 105 transforming the digitally-generated information matrix into its real-world, therefore analog, mark on the document to be secured, i.e. on the original document, and a second sub-channel 110 corresponding to the reading of this mark. In the case of a copy, in addition to these first two channels, a third creation sub-channel 115 is used to reproduce a mark from the mark read, in the real world, and a fourth sub-channel 120 is used to read this trace in order to determine authenticity.

It is noted that in a variant it is possible to perform the second trace based on the first, in a purely analog way (for example by analog photocopying or analog photography) but this fifth analog-analog sub-channel 125, represents, in general, a greater signal degradation than the degradation due to the passage via reading with a high-resolution image sensor.

The third, fourth and/or fifth sub-channels impose an additional degradation of the message, which makes it possible to distinguish an original, an example of an image of which 505 is shown in FIG. 5A, and a copy, an example of an image of which 510, corresponding to the same information matrix as the image 505, is shown in FIG. 5B. As is seen from comparing images 505 and 510, the copy comprises much less fineness of detail, the degradation between these images corresponding to errors reproducing the original information matrix's mark.

As counterfeiters seek to minimize their production costs, the sub-channels used to make the copy and, in particular, the sub-channels leading to the analog trace, in this case the third and fifth channels, are sometimes performed with low marking or print qualities. The messages contained in the copies produced in this way therefore have a significantly lower signal/noise ratio, which makes it possible to detect the said copies even more easily. However, it is to be noted that the cases where the counterfeiter uses print means equal to, or even better than, those used for producing original documents do not generally pose particular problems. In effect, the counterfeiter cannot completely avoid adding noise, resulting in additional errors when the information matrix is demodulated, when the copy is printed. The signal/noise ratio will therefore be reduced by this operation. This signal/noise ratio difference will, in most cases, be sufficient to distinguish captured original information matrices from captured copied information matrices.

For preference the information matrix and, in particular, the fineness of its details, are designed so that the print, whose characteristics are known in advance, is such that the information matrix printed will be degraded. Also, the coded message contains errors, on reading, in a proportion that is noticeable without being excessive. Thus, an additional degradation cannot be avoided by the counterfeiter when the copy is printed. It is stated that the degradation during the printing of the original must be natural and random, i.e. caused by physical phenomena of a locally unpredictable nature, dispersion of the ink in the paper, the natural instability of the printing machine, etc, and not elicited. This degradation is such that the counterfeiter will not be able to correct the errors, the loss of information being by nature irreversible, nor avoid the additional errors, the printing of the copy being itself subject to the same physical phenomena.

To increase security against counterfeiting, the creation of the information matrix is made dependent on one or more parameters kept secret, called secret key(s). You therefore just need to change the secret key in order to return to the initial level of security if the previous key has been discovered by a third-party. In order to simplify the description, it will in general talk of a secret key, it being understood that this key can itself be comprised of several secret keys.

The secret key is used for encrypting or enciphering the initial message, prior to its encoding. As this type of encryption can benefit from an avalanche effect, errors on demodulating or reading the matrix being, in the majority of cases, eliminated by the error-correcting code, then two information matrices, generated from the same key and having messages that only differ by one bit, the minimum distance between two different messages, would appear to be radically different. The same is true for two information matrices comprising messages that are identical, but generated from different keys. The first property is especially advantageous, since the counterfeiter would not therefore be able to detect any recurrent pattern that may possibly be exploitable for creating a counterfeit by analyzing information matrices derived from the same key but bearing different messages. Note that it is also possible to add a random number to the message, such that two information matrices generated with the same key and the same message, but having different random numbers added to the message, will also appear to be radically different.

An information matrix can be viewed as the result of a modulation of a message represented by the symbols of an alphabet, for example binary. In particular embodiments, synchronization, alignment or positioning symbols are added at the level of the message or location assistance patterns are inserted at the level of the information matrix.

The logical diagram illustrated in FIG. 2 shows different steps in generating an information matrix and marking a document, according to a particular embodiment of certain aspects of the method that is the subject of the present invention.

After starting, during a step 185, at least one marking or print characteristic is received or, during a step 190, measured, for example the type of printing, the type of medium, the type of ink used. Then, during a step 195, it is determined whether the surface area of the SIM or its cell number is fixed for the application in question or the client in question. During a step 200, the inking density corresponding to the marking/print characteristics is determined, for example, by reading the density corresponding to the print characteristics in a database or look-up table. During a step 205, the size of the SIM's cells is determined, for example by reading the cell size corresponding to the print characteristics in a database or look-up table. It is noted that the correspondences kept in databases or in look-up tables are determined as described later, especially with regard to FIG. 20. These correspondences are aimed at obtaining a good print quality and a proportion of print errors between a pre-defined first value and a pre-defined second value, for example 5%, 10%, 15 or 20% for the pre-defined first value and 25% or 30% for the pre-defined second value.

Then you receive, during a step 210, a message to be carried by a document is received, this message generally being a function of an identifier of the document, and, during a step 215, at least one secret encryption and/or scrambling key.

The original message represents, for example, a designation of the document, the owner or owners of the attached intellectual property rights, a manufacturing order, a destination for the document, a manufacturing service provider. It is constituted according to techniques known per se. The original message is represented in a pre-defined alphabet, for example in alphanumeric characters.

During a step 215, the message is encrypted with a symmetric key or, for preference, with an asymmetric key, for example a key pair type of the PKI (acronym for “public key infrastructure”) public key infrastructure, to provide an encrypted message. Thus, in order to increase the level of security of the message, the message is encrypted or enciphered in such a way that a variation of a single item of binary information of the message, on input to the encryption, makes a large amount of binary information vary on output from the encryption.

The encryption operates in general on blocks of bits, of fixed size, for example 64 bits or 128 bits. The encryption algorithms DES (acronym for “data encryption standard”), with a key of 56 bits and a message block size of 64 bits, triple-DES, with a key of 168 bits and a message block size of 64 bits, and AES (acronym for “advanced encryption standard”), with a key of 128, 192 or 256 bits and a message block size of 128 bits, can be used since they are widely used and recognized as being resistant to attacks. However, many other encryption algorithms, block-based or sequential, can also be used. Note that, in theory, the block encryption algorithms provide encrypted messages with the same size as the initial message, insofar as this is a multiple of the block size.

AES is recognized to have the highest level of security, but note that it operates on message blocks with a minimum size of 128 bits. If the message to be transmitted has a size that is a multiple of 64 bits, an algorithm such as Triple-DES will be used instead. Finally, it is possible to create a new encryption algorithm, especially if you are restricted to a very small message size, for example 32 bits. Note however that the security of these algorithms will be limited due to the small number of different encrypted messages.

Note however that, in theory, key search cryptographic attacks cannot be applied, at least in their standard form, in cryptography. In effect, the counterfeiter only has access, in theory, to a captured image of the original printed information matrix, and would need to have at least access to the decrypted message in order to launch a cryptographic attack. Yet the message can only be decrypted if it has been descrambled, which requires searching for the scrambling key.

The encryption methods described previously are called “symmetric”, i.e. the same key will be used for decryption. Transporting and storing the keys to the detection module must be done in a very secure way, since an adversary obtaining possession of this key would be able to create encrypted messages that would appear to be legitimate. However, these risks can be limited by using an asymmetric encryption method, in which the decryption key is different from the encryption key. In effect, as the decryption key does not allow messages to be encrypted, an adversary in possession of this key will not be able to generate new valid messages, nor, as a result, information matrices bearing a different message.

During a step 220, the encrypted message is encoded in order to generate an encoded encrypted message. For preference the encoding utilizes convolutional encoding, which is very quick to generate, the decoding itself being rapid by using, for example, the very well-known method developed by Viterbi. If the convolutional encoding used utilizes a nine-degree polynomial generator, and the code rate is two bits on output for one bit on input, you will obtain a code increase of seven dB with respect to the same message simply replicated. This results in a much lower risk of error on decoding. For a message to be encoded containing 128 bits, with the convolutional code described above, you will have an encoded message of 272 bits (there are two bits on output for each of the 128 bits of the code and the eight bits belonging to the encoder's memory for a nine-degree polynomial generator). Note however that many other types of encoding can be performed (arithmetical coding, turbo-code, etc) following the same principle.

For preference, this encoded encrypted message is therefore written in a binary alphabet, i.e. it is comprised of “0” and “1”.

During a step 225, the encoded encrypted message is inserted and replicated in a list of available cells of an information matrix, the unavailable areas of which bear synchronization, alignment or position symbols, or location assistance patterns that, in embodiments, are determined from a secret key. The alignment patterns are, for example, matrices of 9×9 pixels distributed periodically in the information matrix. The encoded encrypted message is thus replicated, or repeated, so that each item of binary information will be represented several times, to correspond to the number of cells available in the information matrix. This replication, which is related to repetition or redundancy encoding, makes it possible to significantly reduce the error rate of the encoded message that will be supplied on input to the convolutional code decoding algorithm. The errors not corrected by the repetitions will be corrected by the convolutional code in most cases.

During steps 235 and 240, the replicated encoded encrypted message is scrambled, according to techniques known as “scrambling”, to provide a scrambled encoded encrypted message.

The function of scrambling the replicated encoded encrypted message consists for preference of successively applying a swap, step 235, and a substitution, step 240, each according to a second secret key, possibly identical to the first secret key, of the message's binary values. The substitution is for preference made using an “exclusive or” function and a pseudo-random sequence.

In this way, the scrambling of the encoded encrypted message is performed in a non-trivial way, by utilizing a secret key, which can be a key identical to the key used for encrypting the message or a different key. Note that is the key is different, in particular embodiments, it can be calculated from a function of the key used for the encryption.

Using a secret key, both for encrypting the message and for scrambling the encoded message, allows a high level of security against counterfeits to be obtained. For comparison, as the existing methods of creating 2D bar codes do not scramble the encoded message, the counterfeiter can easily recreate an original information matrix after having decoded the captured information matrix's message; even if the decoded message is encrypted, they do not need to decrypt said message to identically recreate the information matrix.

The scrambling consists in this case for preference in a combination of swapping, step 235, and, step 240, using an “XOR” or “exclusive or” function, the table of which is

| A | B | S = A XOR B |
|---|---|---|
| 0 | 0 | 0 |
| 0 | 1 | 1 |
| 1 | 0 | 1 |
| 1 | 1 | 0 |

In effect, this type of scrambling avoids an error being propagated (there is no so-called “avalanche” effect: an error on one element of the scrambled message results in one, and only one, error in the descrambled message). The avalanche effect is not desirable since it would make reading the information matrix more difficult when there is one single error in the scrambled message. Yet, as has been seen, errors play an important role in the utilization of the present invention.

The swap, step 235, is determined based on a swapping algorithm to which a key is supplied, said key allowing all the swaps performed to be generated pseudo-randomly. The “exclusive or” function, step 240, is applied between the swapped sequence (the size of which corresponds to the number of cells available) and a binary sequence of the same size also generated from a key. It is noted that if the message is not in binary mode (cells able represent more than two possible values), the swap can be performed in the same way, and the “exclusive or” function can be replaced by a function that performs a modulo addition for the number of possible values for the message with a pseudo-randomly generated sequence comprising the same number of possible values as the scrambled message.

Many swaps depend on an existing secret key. A simple algorithm consists of looping through a loop equipped with an ascending subscript i between 0 and the dimension of the message, N−1, and, for each subscript I, generating a pseudo-random integer number j between 0 and N−1, and then swapping the values of the message at subscript positions i and j.

The pseudo-random numbers can be generated by using, in chained mode, an encryption algorithm (such as those mentioned above) or a hash algorithm such as SHA-1 (second version of the “Secure Hash Algorithm”, which is part of an American government standard). The key is used to initialize the algorithm, this latter being re-initialized at each new step from numbers produced during the previous step.

Once the message's binary data has been swapped, step 235, the bit values are passed through an “exclusive or” (or “xor”) filter with a sequence of pseudo-random bit values of the same length as the message, step 240. In a variant, this step 240 is performed before the swap step 235.

Each of the scrambled replicated encoded encrypted message's binary data is thus modulated in a cell of the information matrix by assigning one of two colors (for example black and white) to binary data “0” and the other color to binary data “1”, the correspondence able to vary over the surface area of the image.

Depending on the print method, step 245, just one of the two colors can be printed, the other corresponding to the original color of the substrate, or having been pre-printed as “background”. For print methods that produce a physical relief (for example embossing or laser engraving), one of the two colors associated to a certain binary value will be chosen, for example arbitrarily.

In general, the image's size, in pixels, is determined by the surface area available on the document, and by the print resolution. If, for example, the available surface area is 5 mm×5 mm, and the matrix's print resolution is 600 pixels/inch (the datum is often expressed in the imperial unit of measurement), the person in the field will calculate the available surface area in pixels to be 118×118 pixels. Assuming that a black border of 4 pixels is added on each side of the matrix, the matrix size in pixels is therefore 110×110 pixels, for a total of 12,100 pixels. If you assume that the size of each cell is one pixel, the information matrix will comprise 12,100 pixels.

Alignment blocks, with a value that is known or can be determined by the detector, can be inserted in the matrix. These blocks can be inserted at regular intervals from the upper left corner of the matrix, for example every 25 pixels, with a size of 10×10 pixels. It is therefore noted that the matrix will have 5×5=25 alignment blocks, each having 100 pixels, for a total of 25×100=2050 alignment pixels, or 2050 message cells. The number of cells available for replicating the encoded message will therefore be 12,100−2,500=9,600. Given that, as described above, the encoded message comprises 272 bits, said message may be fully replicated 35 times, and partially a 36^{th} time (the first 80 bits of the encoded message). It is noted that these 35 replications make it possible to improve the encoded signal's signal/noise ratio by more than 15 dB, which allows a very low risk of error when the message is read.

Two examples of representations of the information matrix resulting from the document securization method illustrated with regard to FIG. 2 are given in FIG. 4A, matrix 405 without visible alignment block, and in FIG. 4B, matrix 410 with visible alignment blocks 415. In this last figure, the alignment blocks 415, formed of black crosses on a white background, are very visible because of their regularity. In other embodiments, as represented in FIG. 4A, these blocks noticeably present the same appearance as the rest of the image. Lastly, as in 4A and 4B, a black border 420 can be added all around the message and any alignment blocks.

It is noted that, apart from the border and alignment blocks, which can be pseudo-random, the binary values “0” and “1” are for preference equiprobable.

In a variant, the border of the information matrix is constituted of cells with a larger dimension that the cells of the rest of the marking area in order to represent a more robust message. For example, to constitute a square cell of the border, four peripheral cells of the information matrix are associated and the scrambled encoded encrypted message is represented, in this border. In this way, the content of the border will be very robust to subsequent degradations of the mark, in particular the acquisition of its image or its copy on another document.

In other variants, a message in addition to the message borne by the information matrix is borne by the document, for example on an electronic tag or on a two-dimensional bar code. As described below, the additional message can represent the initial message or a message utilized in authenticating the document, for example representing the keys utilized in generating the information matrix, the data associated to these keys in a remote memory, the error quantity threshold to be used for deciding whether the document is authentic or not.

In variants, after steps 235 and 240, an additional step is carried out of partially scrambling the scrambled replicated encoded encrypted message according to a third secret key. The scrambled replicated encoded encrypted message can itself therefore be partially scrambled, with a key that is different from the key(s) used in the previous steps. For example, this additional partial scrambling concerns about 10 to 20% of the cells (the number is generally fixed). The cells that undergo this additional scrambling are chosen pseudo-randomly by means of the additional scrambling key. The values of the selected cells can be systematically modified, for example changing from “1” to “0” and from “0” to “1”, for binary values. In a variant, the selected cells can be passed through an “exclusive or” filter generated from the additional scrambling key, and will therefore have a 50% probability of being modified.

The aim of this additional scrambling is to ensure that a detector that is not equipped with the additional scrambling key can nevertheless extract the message correctly and detect copies. However, such a detector falling into unauthorized hands does not contain all the information or keys needed to reproduce an original. In effect, not having the additional scrambling key, the adversary will be able to generate and print an information matrix that will be recognized as a copy by a detector equipped with the additional scrambling key. In general, the detectors considered to be less secured will not be equipped with the additional scrambling key.

Other variants on this principle, consisting of not providing all the keys or parameters used for creating the information matrix, will be discussed later.

During the step 245, a document is marked with the information matrix, for example by printing or engraving, with a marking resolution such that the representation of the information matrix bears errors due to said marking step in such a way that any reading of said information matrix reveals a non-zero error rate. During this marking step, a mark is therefore formed comprising, as a result of the physical conditions of the marking, at least partially random or unpredictable local, i.e. affecting representations of cells of the information matrix individually, errors.

The physical conditions of the markings comprise, notably, the physical tolerances of the means of marking, carrier, and, in particular, its surface state and material, for example ink, possibly deposited. The term unpredictable signifies that you cannot determine, before the physical marking of the document, which cells of the information matrix will be correctly represented by the marking and which cells of the matrix will be erroneous.

For each of the secret keys used, if the previous key has been discovered by a third-party the secret key just needs to be changed in order to return to the initial level of security.

It is noted that the encoding and possible replication enable, firstly, the robustness of the message to be increased significantly with regard to degradations and, secondly, the document to be authenticated, by estimating or measuring the number or rate of errors affecting a reading of the mark of the information matrix.

It is noted that the encoding, encrypting, scrambling, additional scrambling and replication steps are reversible, provided that the secret key or keys are known.

When original information matrices, captured and printed with a resolution of 1,200 points per inch, with cells of 8×8, 4×4, 2×2 et 1×1 pixel(s), are examined, it is noted that the, high resolution, reading of the binary value represented by each cell:
presents practically no errors with cells of 8×8 pixels,
presents some errors with cells of 4×4 pixels,
presents many errors with cells of 2×2 pixels and
presents, for the cells of 1×1 pixels, an error rate that is so close to the maximum of 50% that the error corrections would probably be insufficient and the degradation due to copying would be unnoticeable because the error rate would be unable to change.

An optimum lies between the extreme dimensions of the cells and, in the limited choice represented here, one of the cases in which the cells have 4×4 or 2×2 pixels is optimal. A method for determining this optimum is given below.

As shown in FIG. 3, in a particular embodiment, the method for authenticating a document comprises, after the start 305:
a step 310 of receiving at least one secret key,
a step 315 of acquiring an image of a mark of an information matrix on said document, for preference with an array image sensor, for example a video camera,
a step 320 of locating the information matrix's mark,
a step 325 of searching for alignment and location patterns of the information matrix's cells, in said mark,
steps 330 and 335 of descrambling elements of the messages utilizing a secret key, to obtain a replicated encoded encrypted message, for carrying out a substitution, step 330, and a swap, step 335,
a step 340 of accumulating replications of the replicated encoded encrypted message for obtaining an encoded encrypted message,
a step 345 of decoding the encoded encrypted message to provide an encrypted message,
an optional step 350 of decrypting the encrypted message, utilizing a secret key,
a step 355 of determining the quantity of errors affecting the encrypted message utilizing the redundancies associated to the message by the encoding step and
a step 360 of deciding whether the document that carried the information matrix's mark is a copy or an original document.

For preference, each secret key is random or pseudo-random.

Thus, optionally, the authentication method comprises a step of decrypting the original message, utilizing an encryption key, symmetric or asymmetric. Depending on the encryption type, with symmetric keys or asymmetric keys, the decryption key is identical to or different from the encryption key. Identical keys are used for symmetric encryption, while different keys are for asymmetric encryption. An important advantage of asymmetric encryption is the fact that the decryption key does not allow valid encrypted messages to be generated. Thus, a third-party having access to a detector and managing to extract the decryption key, will not be able to use it to generate a new valid message.

In order to process a mark formed on a document, this is, first of all, captured by an image sensor, typically an array image sensor of a camera, for example monochrome. The format of the digitized captured image is, for example, a dot matrix (known under the name “bitmap”).

FIG. 5 shows an example of a digitized captured image of dimensions 640×480 pixels with eight binary data per pixel (namely a scale of 256 levels of grey). The successive reading functions utilized are detailed below.

First of all, a function searching for each of the 25 alignment patterns in the image received is performed. The output from this function contains 50 integer values representing the vertical and horizontal positions of the 25 alignment patterns. This function is performed in two steps:
one step to find the overall position of the information matrix in the digitized captured image and
one step during which a local search (on a sub-section of the image) of each of the alignment patterns is performed to determine their positions.

To perform the first step, the person in the field can draw on the prior state of art, for example, document U.S. Pat. No. 5,296,690. Alternatively, a simple fast algorithm consists of delimiting the region of the digitized captured image that contains the information matrix by searching for abrupt grey-scale transitions, line by line and column and column or after having, firstly, summed all the lines, and, secondly, summed all the columns in order to constitute a single line and a single column on which the search is performed. For example, the grey-scale derivatives having the highest absolute values correspond to the edges of the information matrix and the positions of the four corners can be roughly estimated.

To perform the second step, the estimated positions of the four corners of the information matrix are used to estimate the position of the alignment patters, according to known geometric techniques.

Standard geometric techniques can be used to determine the translation, scaling and angle of rotation of the information matrix in the image captured by the image sensor. Reciprocally, these translations, scaling and angle of rotation can be used to determine the position of the corners of the information matrix. A successive approximation can thus be carried out via iteration of these two steps.

In general, you have an estimate of the position of each alignment pattern, with a level of precision of X pixels more or less in vertical and horizontal coordinates. This value X depends on the application conditions, especially the ratio between the capture resolution and the print resolution, the maximum reading angle tolerated, and the accuracy of the estimates of the positions of the information matrix's four corners. A value X of 10 pixels is reasonable, in which case you have a search area of 21×21 pixels. A convolution is performed between the alignment pattern and the alignment block, this latter possibly being scaled if the ratio between the capture resolution and the print resolution is other than one. The position of the resulting convolution matrix with the maximum value corresponds to the alignment block's starting position.

The positions of the 25 alignment patterns are stored in memory. This set of data is used in the demodulation step, in order to determine with maximum precision the position of each of the cells of the information matrix in the captured image.

For each binary value, the closest alignment pattern of the corresponding cell is used as the starting point for estimating the position of the cell in terms of pixels of the captured image. Using the estimated rotation and scale and known relative position of the cell in the digital information matrix, the cell's central position is estimated in the captured information matrix, according to known geometric techniques.

Applying a descrambling function, an inverse function of the scrambling function applied in producing the original information matrix, allows the original replicated message affected with errors to be retrieved. If the indicators are kept, you then have real or integer numbers, which can be positive or negative, in which case the “exclusive or” function cannot be applied directly. To obtain an estimate of the descrambled message from the indicators, you thus just need to multiply the indicator by −1 when the “exclusive or” filter's value is 0, and by +1 when its value is 1. Note that the swap is performed in the same way for the different types of indicator (binary, integer and real).

Then, a step is used to estimate the value of each bit of the encoded message, according to the observation of the captured values of the descrambled information matrix's cells. For this purpose, the next step consists of determining an indicator of the binary value that has been assigned to the cell, by considering that black has a binary value of “0” and white “1” (or vice versa). This indicator can, for example, be the average luminance (or the average grey-scale) of a small neighboring area surrounding the centre of the cell (and corresponding at most to the surface area of the cell) or the highest value of this small neighboring area, or the lowest luminance value in this neighboring area. A useful approach can be to define two neighboring areas, a small neighboring area surrounding the centre of the cell and a larger neighboring area surrounding and excluding the smallest neighboring area. The indicator can thus be based on comparing luminance values in the external neighboring area and in the smallest neighboring area, called the interior area. A comparison measurement can be the difference between the average luminance in the interior neighboring area and the average luminance in the larger neighboring area.

Once the indicator of the binary value has been determined for each of the cells of the information matrix, it is advantageous to carry out additional processing of these indicators. In effect, depending on the transformations that the information matrix has undergone, from the digital information matrix to the captured information matrix, the indicators can present a deviation. Simple additional processing to reduce this deviation consists of subtracting the average or median indicator value and, possibly, normalizing these indicators over a range from −1 to +1. These normalized indicators can be used to determine the most probable binary values, by comparing them to a threshold value, for example the value “0”, the higher values being assigned a “1” and the lower values a “0”, which will lead to the same number of binary values “0” and “1”.

In a preferred variant, for each binary value searched for, the sum of the values of indicators is done over all its representations, then compared to a value serving as a threshold. This processing, with a heavier use of resources, in fact gives greater reliability in this step.

It is recalled that, for the example described earlier, the information matrix comprises 35 times the encoded message of 272 binary values, with 80 of them being duplicated a 36^{th} time. For each value of the encoded message, therefore, there are 35 or 36 indicators. The concentration, or accumulation, amounts to retaining only one final value (binary, real or integer) depending on these many representations of the same initial binary value. For example, an average of the 35 or 36 indicators is done, a positive average being interpreted as a “1” and a negative value as a “0”. In this way, the averages of the indicators can be compared to the threshold value “0”.

According to variants, more complex statistical treatments are applied to the indicators, in certain cases requiring a teaching phase. For example, non-linear operations can be performed on the averages of the indicators in order to estimate the probability that the corresponding initial binary value is respectively “1” and “0”. Estimating a probability can in effect allow the decoder's result to be fine-tuned.

At the end of the accumulation step, you have an encoded message comprising redundancies intended to enable errors to be corrected or, at least, detected.

The decoder, which, in the case of a convolutional code, is preferably based on the Viterbi method, provides on output the encrypted message, the size of which is, in the example described just now, 128 bits.

Then the decoded encrypted message is decrypted by using the encryption algorithm used for encryption, for preference AES for blocks of 128 bits, in reverse mode.

It is recalled that a part of the message can have been reserved for containing a mathematical function, for example a hash, of the rest of the message. In the example mentioned above, 16 bits are reserved for containing a mathematical function of the remaining 112 bits of the message. “Padding” bits are added to the remaining 112 bits of the message, and an SHA-1 type of hash or digest is calculated from the message to which the padding bits are added and the same secret key used on creation. If the first 16 bits of the hash result correspond to the 16 reserved bits, the message's validity is confirmed and the reading procedure can pass to the next step. Otherwise, the 112-bit message is considered not valid. There can be various reasons for this invalidity: incorrect reading, message generated in a non-legitimate way, etc. A more extensive analysis, possibly with human intervention, will enable the exact cause of the problem to be determined.

The 112-bit decrypted message is interpreted so as to provide on output the significant information to the user. This information can, in itself, provide the user important information about the nature of the document or carrier that contains the information matrix: a product's use-by date, distribution chain tracking, correlation with other information from the same document, etc. This information can also be used to interrogate a database, which may add new information, confirm the validity or verify the origin of the document, detect a double, etc.

However, as previously explained, reading and analyzing the transmitted message does not enable a definitive response to the following question: “is the document in question an original or a copy?” In effect, a good-quality copy of an original document will contain a readable message, with information that is in theory valid. Even if the information extracted from a copy is deemed not valid (for example, if the copy of the document has passed over a distribution network that does not correspond to the information extracted from the information matrix), it is important to know the exact cause of the fraud: legitimate product passed over an illegitimate channel, or counterfeit? Different methods for determining the source of the document (original or copy) are now presented.

Many decoders provide a measurement of the error rate on the encoded message. For example, for a convolutional code, the Viterbi detector calculates the shortest path, based on a given metric, in the decoder's state space that lead to the observed encoded message. The metric chosen depends on the representation of the encoded data supplied to the decoder. If the data supplied are binary, the metric will be based on the Hamming distance, namely the number of positions or the different bit values, between the code supplied on input to the decoder and the code corresponding to the shortest path in the state space. If the data are not binary but quantified more finely, or if they are integer or real, an appropriate metric will be used.

It doesn't matter which metric is used for measuring the message's error rate, this latter will in theory be higher for a copied captured information matrix than for an original captured information matrix. A decision threshold is necessary to determine the information matrix's type (original or copy). To calculate this decision threshold, the following approach can be taken, for example:
generate a representative sample of the application, for example 100 different original information matrices, each captured three times under the application conditions, for a total of 300 captured images;
measure the error rate for each of the 300 captured images;
calculate a measurement of the average value and dispersion of the sample of error rates, for example the arithmetical average and standard deviation of the sample;
according to the measurements of the average value and dispersion, determine the error rate decision threshold above which the information matrix will be considered to be a copy. This decision threshold can be, for example, equal to the average+4*standard deviation;
a lower decision threshold can be set for detecting possible anomalies in the printing of the original information matrices, for example average−3*standard deviation, below which the user would be notified of the sample's especially low error rate;
if the information matrix's capture conditions are unequal, such that the error rate is too high due too poor capture conditions, you can also consider an area where it is not possible to determine the information matrix's source with certainty; you therefore request a re-capture of the image. This area can, for example, be located between the average+2*standard deviation, and the decision threshold (in the current example located at average+4*standard deviation).

The error rate measurement obtained during the decoding step is in theory calculated directly during the decoding step, its use is therefore very practical. As has been seen, this error rate on the encoded message is based on the accumulation, in our example, of the 35 or 36 indicators for each bit of the encoded message. However, in certain cases it is desirable to make a finer analysis of the error rate, based directly on the indicators and not on the accumulated values of these indicators. In effect, a finer analysis of the error rate can enable better detection of copied information matrices.

To do this, it is necessary to determine the positions of the errors on each of these indicators. For this, you start by determining the original encoded message. This original encoded message can be supplied by the decoder. If not, it can be calculated by encoding the decoded message. It is noted that this encoding step is especially cost-effective when a convolutional code is used. The encoded message is then replicated so as to obtain the original replicated message. This original replicated message can be compared to the original replicated message affected with errors obtained previously, and a measurement of the error rate in a suitable metric can be calculated. If the replicated message affected with errors is represented in binary values, the number of errors (equivalent to the Hamming distance) can be counted directly, and normalized by dividing it by the size of the replicated message. If the values of the indicators are retained, the replicated message affected with errors is represented in integer or real values. In that case, the replicated messages can be assimilated to vectors, and a metric will be chosen that allows a distance between these vectors to be calculated. For example, the linear correlation index between two vectors, ranging from −1 to 1, is a widely-used measurement of similarity between vectors. Note that a measurement of the distance between vectors can be calculated simply by taking the negation of a measurement of similarity, in this case the negation of this linear correlation index.

Clearly, many other measurements of distance can be used keeping the spirit of the method. The measurement of distance on the replicated message allows a finer analysis, at the level of the elementary units of the message represented by the cells of the matrix. It can be desirable to push the analysis to an additional level of accuracy, by considering the different geographic areas of the matrix separately. For example, you may want to analyze and determine the error rate in a specific area, such as the upper left corner of the matrix. This possibility is particularly interesting when, for example, the information matrix has been degraded locally (scratch, bend, wear, stain, etc), or when it has been captured unevenly (parts too dark or too light, or out of focus).

In effect, you want to avoid these degradations, which can affect original information matrices, resulting in a high error rate for these latter. An analysis with local components can therefore make it possible to ignore, or give a lower weight to, the degraded areas that bear a higher error rate.

This can be accomplished by considering the swapped or scrambled message instead of the replicated message. In effect, as the information matrix is generated in a fixed way (independent of a key) from the scrambled message and alignment blocks, it is consequently easy to extract portions of the swapped or scrambled message corresponding to precise geographic areas. It is noted that if you make use of the swapped message, instead of the scrambled message, you avoid the step applying an “exclusive or” filter in order to obtain the scrambled original message.

For an arbitrary geographic area, you can apply the previously described measurements of distance between the swapped or scrambled original message and the swapped or scrambled message affected with errors. In all cases, it is possible to include the alignment blocks in the analysis.

Many algorithms controlling the use of different geographic areas are possible. In certain cases, it also possible to make use of a human operator, who would perhaps be able to determine the source of the degradations (accidental, deliberate, systematic, etc). However, the analysis must often be done automatically, and produce a specified result: original, copy, reading error, etc. A generic approach therefore consists of separating the information matrix into exclusive areas of the same size, for example 25 squares of 22×22 pixels for the matrix of 110×110 pixels described in the above example. You therefore calculate 25 values of the distance between the original messages and the messages affected with errors corresponding to these distinct geographic areas. Then, you extract the eight highest values of distance, corresponding to the eight areas having undergone the least degradation. Finally you calculate an average error rate over these eight geographic areas. You then favor the areas of the information matrix that had the greatest probability of being read correctly.

It is noted that, as several error rate indicators can be calculated, according to the encoded, replicated, swapped or scrambled message, and also according to the various geographic areas, you can group the various error rates measured together, so as to produce a global error rate measurement.

Starting from the binary values of the message of 255 binary values, the decoder determines the decoded message and the number, or rate, or errors. In the case of decoders that do not supply the number or rate of errors, the decoded message is re-encoded and this re-encoded message is compared to the message coming from the captured information matrix.

From the binary values, you determine whether the captured analog information matrix is an original or a copy, according to the number of errors detected.

In the case in which the message can be decoded and the position of errors determined, the output from this decoding step is a list of 255 binary values which are equal to “1” for the errors and “0” when there is no error for the corresponding binary value in the decoded message.

It is noted that, the number of errors that can be decoded being limited, while the decoded message cannot be determined, you know that the number of errors is greater than the detection limit in question.

When the message is decoded, by using the secret key, it is deciphered. It is noted that using asymmetric keys makes it possible to increase the security of this step.

According to the inventors' experience, print parameters generating, as a result of the physical tolerances of the marking means used, the state of the document's surface and the possible deposit performed, at least 5 percent and, preferably, 10 to 35 percent and, even more preferably, between 20 and 25 percent of symbols incorrectly printed provide a good level of performance in terms of detecting copies. To reach this error rate, the print parameters that influence the degradation of the printed message are varied.

Below is a description, in greater detail, of how the SIM's conception is optimized according to the print conditions.

It is recalled, firstly, that the SIM in digital format, before printing, contains no errors. In effect, there is no random, deliberate, or “artificial” generation of errors. These cases are not, moreover, print errors according to this invention: “print error” refers to a modification in a cell's appearance that modifies the interpretation of the information borne by this cell, during an analysis free from reading or capture errors, for example, microscopic. It is noted that while the cells often originally have binary values, the captured values are frequently in grey-scale and you therefore have a non-binary value associated to a cell; this latter can, for example, be interpreted as a probability on the cell's original binary value.

Thus it is the printed version of this SIM that contains errors. The errors in question, utilized in the present invention, are not caused artificially, they are caused naturally. In effect, the errors in question are caused, in a random and natural way, during the marking step, by printing the SIM at a sufficiently high resolution.

These errors are necessary, even though their mix is delicate. In effect, if the SIM is marked without errors (or with a very low error rate), a copy of this SIM produced under comparable print conditions will not comprise more errors. Thus, an “almost perfectly” printed SIM can obviously be identically copied with an analog means of marking. In contrast, if the SIM is marked with too high a number of errors, only a minority of cells will be likely to be copied with additional errors. It is therefore necessary to avoid a marking resolution that is too high, since the possibility of distinguishing originals from copies is reduced.

Expressly, a SIM's print resolution cannot be varied. In effect, most print means print in binary (presence or absence of an ink dot) with a fixed resolution, and the grey or color levels are simulated by the various screening techniques. In the case of offset printing, this “native” resolution is determined by the plate's resolution, which is, for example, 2,400 dots/inch (2,400 dpi). Thus, a grey-scale image to be printed at 300 pixels/inch (300 ppi) may in reality be printed in binary at 2,400 dpi, each pixel corresponding approximately to 8×8 dots of the raster.

While the print resolution cannot, generally, be varied, you can, on the other hand, vary the size in pixels of the SIM's cells, such that one cell is represented by several print dots and in particular embodiments, the part of each cell whose appearance is variable, i.e. printed in black or white, in binary information matrices. Thus, you can for example represent a cell by a square block of 1×1, 2×2, 3×3, 4×4 or 5×5 pixels (non-square blocks are also possible), corresponding respectively to resolutions of 2,400, 1,200, 800, 600 and 480 cells/inch.

According to certain aspects of the present invention, you determine the number of pixels of the cell leading to a natural degradation on printing that make it possible to maximize the difference between originals and copies.

The following model allows a response to be made to this determination, even if it results from a simplification of the processes utilized. Assume that a digital SIM is constituted of n binary cells, and that there is a probability p that each cell is printed with error (such that a ‘1’ will be read as a ‘0’ and vice-versa).

It is assumed that the copy will be made with equivalent print means, which is expressed by the same probability p of error on the cells during copying. Note that an error probability p greater than 0.5 does not have any meaning in the context of this model, a value for which there is zero correlation between the printed SIM and the digital SIM (0.5 therefore corresponds to the maximum degradation).

Based on a captured image, the detector counts the number of errors (the number of cells not corresponding to the original binary value) and makes a decision about the nature of the SIM (original/copy) on the basis of this number of errors. It is stated that, in practice, the captured image is generally in grey-scales, such that it is necessary to threshold the values of the cells to obtain binary values. So that information is not lost during the thresholding step, the values in grey-scales can be interpreted as probabilities on the binary values. However, for the rest of our discussion, we will consider that binary values for the SIM's cells are deduced from the image received.

In order to measure the reliability of copy detection according to each cell's error probability p, you make use of an indicator I, which is equal to the difference between the average number of errors for the copies and for the originals, normalized by the standard deviation of the number of errors of the originals. Therefore you have I=(Ec−Eo)/So, where:
Eo is the average number of errors for the originals,
Ec is the average number of errors for the copies and
So is the standard deviation of the number of errors of the originals.

It is noted that, for reasons of simplicity for the model, the standard deviation of the copies is ignored. Since, in our model, there is a probability p that each cell is printed with an error, you can apply the formulae for the average and standard deviation of a binomial distribution. The values of Eo, Ec and So are therefore found according to p and n:

Eₒ=n·p

E_{C}=2·n·p·(1−p)

Sₒ=\sqrt{n·p·(1−p)}

The value of the indicator I is therefore:

$$I = \sqrt{n} \cdot \frac{p - 2 {p}^{2}}{\sqrt{p \cdot ( 1 - p )}}$$

FIG. 20 shows with solid lines 700 the value of the indicator I according to p, for p between 0 and 0.5, normalized on a scale of 0 to 1. The following are therefore noted: for p=0 and p=0.5, namely the minimum and maximum error rates, you have an indicator equal to 0, and consequently no separation between the originals and the copies. In effect, without any degradation of the cells on printing, there is no possibility of separation between originals and copies; in contrast, if the degradation is very high (i.e. close to 0.5), there are practically no more cells left to be degraded, and as a consequence little possibility of separation between originals and copies. It is therefore normal that the indicator passes via an optimum: this corresponds to the value p=(3−\sqrt{5})/4≈0.191 or 19.1% of unconnected print errors.

We have found an optimum of degradation that does not take into account the number n of cells available. Yet it is observed that the indicator I increases according to n: it would therefore be necessary for n to be as large as possible. However, relatively frequently there is a fixed surface area available for printing the SIM, for example 0.5 cm×0.5 cm. Thus a matrix of 50×50 cells of size 8×8 pixels occupies the same size as a matrix of 100×100 cells of size 4×4 pixels. In this latter case there are four more cells, but it is extremely likely that the probability of error p will be higher. The determination of the optimum value p should therefore take into account the fact that a larger number of cells is used for a higher resolution. If you make the approximative hypothesis that the probability p is inversely proportional to the surface area available for a cell, you have p=α·n where α is a constant, since the total surface area is divided by the number of cells n. Indicator I is therefore expressed as:

$$I = α \cdot \sqrt{p} \cdot \frac{p - 2 {p}^{2}}{\sqrt{p \cdot ( 1 - p )}}$$

As shown on the curve with broken lines 705 of FIG. 20, taking into account changes in p according to n, the indicator passes through a maximum for the value p=(9−\sqrt{33})/12≈0.271 or 27.1% of unconnected errors.

Thus using an error rate between 20 and 25% is preferred, as you are therefore between the optimums of 19.1% and 27.1% found above. The optimum of 19.1% corresponds to the case in which you have a fixed number of cells, for example if the reading procedure can only read the SIMs with a fixed number of cells, while the optimum of 27.1% corresponds to the case in which there is no constraint on the number of cells, while there is a constraint on the physical dimension of the SIM.

Variants or improvements for utilizing certain aspects of the present invention are described below.

1) Utilizing non-binary information matrices. Implementation is not limited to information matrices of a binary type. At all steps, to pass from the initial message to the information matrix, the elements of the message can have more than two different values. Take the case in which the cells of the information matrix can have 256 different values, which corresponds to printing an image in grey-scale with a value comprised between 0 and 255. The scrambled and encoded messages will also have 256 values. To determine the scrambled encoded message from the encoded message, the swap function can remain the same, but the “exclusive or” function can be replaced by a modulo addition 255 and the pseudo-random sequence used for this module addition 256 also contains values comprised between 0 and 255.

The initial message and the part of the encoding corresponding to the application of an error-correcting code may again, but not necessarily, be represented by binary values. However, the replication sub-step will have to transform a binary encoded message into a replicated message having values, for example, between 0 and 255 (8 bits). A way of doing this consists of grouping the binary encoded message by units of 8 successive bits, then representing these units on a scale of 0 to 255.

2) Determining copies based on the result of the decoding, without reading the error rate. In the embodiments described with respect to the figures, the error rate is used to determine the source of a captured information matrix: original or copy. It was also mentioned that the error rate can only be measured if the captured encoded message of the information matrix can be decoded. The steps needed to ensure that the message can be decoded, in most cases, up to a wanted error rate have been explained In this way, you can ensure that, in most cases, the error rate is also measurable for the copies, provided that there is a sufficient quantity of them.

In certain cases, you do not rely (uniquely) on the error rate to determine whether the information matrix is a copy. This is the case in particular when the quantity of information inserted in the information matrix is very large with respect to the surface area or the number of pixels available, such that the encoded message cannot be replicated a large number of times (in our example, the encoded message is replicated 35 or 36 times). You therefore seek to make sure that the original information matrices are read correctly; on the contrary, the copied information matrices are, in most cases, incorrectly read. A correct reading makes it possible to make sure that the information matrix is original; on the contrary an incorrect reading is not necessarily a guarantee that the information matrix is a copy.

The quantity of information is high if the message in encrypted asymmetrically, for example by using the RSA public-key encryption algorithm with encrypted message sizes of 1024 bits, or if you seek to symmetrically encrypt the picture of the holder of an identity card (2000 to 5000 bits). If the size of the information matrix is limited (for example less than one square centimeter) you will not be able to replicate the encoded message a large number of times; depending on the print quality, you will probably be in the situation in which a copy's message is not readable.

3) Utilizing information matrices containing several messages. It is possible to create information matrices containing several messages, each using different keys, in a recursive way. This is especially useful for applications where you assign different authorization levels to different verification tools, or users. This is also useful for obtaining several layers of security: if a more exposed key is discovered by a third-party, only a part of the information matrix can be counterfeited.

To simplify the extraction of these particular embodiments, take the case of two messages (message 1 and message 2). Messages 1 and 2 can be grouped at several levels. For example:
messages 1 and 2 encrypted separately with a key 1 and a key 2 are concatenated. Key 1 (or a group of keys 1) is used for the steps of swapping, scrambling, etc. Message 2 can only be decrypted on certain readers equipped with key 2. Authentication, to determine whether you have an original matrix or a copied matrix, can be performed over the totality of the matrix using key 1. This approach is advantageous if the image is captured by a portable tool that communicates with a remote server equipped with key 2, if communication is costly, long or difficult to establish: in effect, the volume of data to be sent is not very important;
scrambled message 1 and scrambled message 2 are concatenated, and the information matrix is modulated from the concatenated scrambled messages. It is noted that the two messages have positions that are physically separated in the information matrix;
replicated message 1 and scrambled message 2 are concatenated, and the concatenated message is swapped and scrambled using key 1. It is noted that the positions of scrambled message 2 depend on both key 1 and key 2; as a result, both keys are needed to read message 2.

Using several secured messages with different keys makes it possible to manage different authorization levels for different users of the verification module. For example, certain entities are authorized to read and authenticate the first message, others can only authenticate the first message. An autonomous verification module, with no access to the server for verification, would not in general be able to read and/or authenticate the second. Many other variants are clearly possible. It is noted that the above considerations can be extended to information matrices having more than two messages.

4) Inserting a falsification- or error-detecting code. The higher the error rate, the greater the risk that the message is not decoded correctly. It is desirable to have a mechanism to detect incorrectly decoded messages. Sometimes, this can be done at the application level: the incorrectly decoded message is not consistent. However, you cannot make use of the decoded message's meaning to check its validity. Another approach consists of estimating the risk that the message is incorrectly decoded, making use of a measurement of the encoded message's signal/noise ratio, with respect to the type of code and decoding used. Graphs exist, in particular we refer to “Error Control Coding”, Second Edition, by Lin and Costello. For example, page 555 of this book shows that for a convolutional code with a memory of 8 and a rate of ½, with soft decoding at continuous input values, the error rate per encoded bit is 10̂(−5) for a signal over noise ratio of 6 dB.

Another approach, which can supplement the previous, consists of adding a hashed value of the message to the encrypted message. For example, you can use the SHA-1 hash function to calculate a certain number of hash bits of the encrypted message. These hash bits are added at the end of the encrypted message. At detection, the decoded message's hash is compared to the concatenated hash bits; if the two are equal, you can conclude with great probability that the message is correctly decoded. It is noted that with a number of 16 hash bits, there is one chance in 2̂16 that an error is not detected. It is possible to increase the number of hash bits, but this is done at the expense of the number of cells available for replicating the encoded message.

5) Hashing can be used with the aim of adding a layer of security. Assume in effect that symmetric encryption is used, and a third-party gets hold of the encryption key. This adversary can generate an unlimited number of valid information matrices. It is noted, however, that if an additional scrambling key has been used initially and it is not in the third-party's possession, the information matrices generated by the third-party will be detected as copies by a detector equipped with this additional encryption key. A hash of the raw or encrypted messaged can however be concatenated to the encrypted message, this hash being dependent on a key that in theory is not stored on the detectors that the third-party can potentially access. Verification of the hash value, possibly on secured readers, makes it possible to make sure that a valid message value has been generated. In this way, a third-party equipped with the encryption key, but not the hash key, is not able to calculate a valid hash for the message. In addition, this valid hash makes it possible to ensure, in a general way, the consistency of the information contained in the message.

6) Using information matrices in the server system. Processing is carried out entirely in a server remote from the means of marking or the means of image capture or, for authentication, in an autonomous reader possibly having a set of secret keys.

In a preferred variant, the server allows the message to be read and the portable reader allows copies to be detected.

For preference, one part of steps 320 to 350 of reconstituting the original message is performed by a reader at the location where the information matrix's image is captured and another part of the reconstitution step is carried out by a computer system, for example a server, remote from the location where the information matrix's image is captured. The data relating to creating and reading information matrices (keys and associated parameters) can thus be stored in a single place or server, highly secured. Authorized users can connect to the server (after authentication) in order to order a certain number of information matrices that will be affixed on the documents to be secured and/or tracked. These information matrices are generated by the server, and the keys used are stored on this server. They are transmitted to the user, or directly to the printing machine, in a secure way (by using means of encryption for example).

In order to carry out a quality check directly on the production line, capture modules (sensor+processing software+information transfer) allow the operator to capture images of printed information matrices, these latter being automatically transmitted to the server. The server determines the keys and the corresponding parameters, carries out the reading and authentication of the captured information matrices, and returns a result to the operator. It is noted that this method can also be automated through industrial vision cameras automatically capturing an image of each printed information matrix that passes on the line.

If the portable capture tools in the field can connect to the server, a similar method can be established for the reading and/or authentication. However, this connection is not always desirable or possible, in which case some of the keys must be stored on the authentication device. Using a partial scrambling key at creation therefore proves to be especially advantageous, since if this is not stored on the portable reading tool this latter does not have sufficient information to create an original information matrix. Similarly, if the encryption is performed asymmetrically, the decryption key stored on the portable reading tool does not enable the encryption, and therefore the generation, of an information matrix containing a different message that would be valid.

In certain applications, the information matrix verification and distribution server must manage a large number of different “profiles”, a profile being a unique key-parameter pair. This is especially the case when the system is used by different companies or institutions, who want to secure their documents, products, etc. You can see the advantage for these different users to have different keys: the information contained in information matrices is generally of a confidential nature. The system can therefore have a large number of keys to manage. In addition, as is common in cryptography, you want to renew the keys at regular intervals. The multiplication of keys must clearly be considered from the point of view of verification: in effect, if the verification module does not know in advance which of the keys has been used for generating the matrix, it has no other choice but to test the keys available to it one by one. Inserting two messages into the information matrix, each using different keys, proves to be very advantageous in this mode of utilizing the invention. In effect, you can therefore use a fixed key for the first message, such that the verification module can directly read and/or authenticate the first message. In order to read the second message, the first message contains, for example, an indicator that enables the verification module to interrogate a secured database, which will be able to supply it with the keys for reading and/or authenticating the second message. In general, the first message will contain information of a generic nature, while the second message will contain data of a confidential nature, which will possibly be personalizable.

7) Detection threshold/Print parameters. In order to facilitate autonomous authentication of the information matrix, the decision threshold or thresholds, or other parameter relating to the printing, can be stored in the message or messages contained in the information matrix. Thus, it is not necessary to interrogate the database for these parameters, or to store them on the autonomous verification modules. In addition, this makes it possible to manage applications or information matrices, of the same nature from the application point of view, that are printed by different methods. For example, the information matrices applied to the same type of document, but printed on different machines, might use the same key or keys. They may have print parameters stored in the respective messages.

8) The swapping of the replicated message, described above, is an operation that can be costly. In effect a high number of pseudo-random numbers must be generated for the swapping. In addition, during detection, in certain applications a multitude of scrambled messages can be calculated on the captured image, such that the lowest error rate measured on this multitude of scrambled messages is calculated. Yet each of these scrambled messaged must be de-swapped, and this operation is all the more costly if there is a large number of scrambled messages.

The cost of this swapping can be reduced by grouping together a certain number of adjacent units of the replicated message and swapping these grouped units. For example, if the replicated message has binary values and numbers 10,000 elements, and the units are grouped by pairs, there will be 5,000 groups, each group able to take 4 possible values (quaternary values). The 5,000 groups are swapped, then the quaternary values are to be represented by 2 bits, before applying the exclusive-OR function and/or modulation. In variants, the exclusive-OR function is replaced by a modulo addition (as described in patent MIS 1), then the values are again represented by bits.

For encoded messages whose size is a multiple of two, the number of grouped units can be set to an uneven number, for example 3, so as to avoid two adjacent bits of the encoded message being always adjacent in the SIM. This increases the security of the message.

During reading, inverse swapping is performed on groups of values, or on these values accumulated on a single number so as to be separable subsequently.

A method for optimizing print parameters for digital watermarks is described below. As an example we will take spatial digital watermarks.

The digital watermarks use masking models for predicting the quantity of possible modifications in an image that will be unnoticeable, or at least will be acceptable from the point of view of the application. These modifications will thus be adjusted according to the image's content and will thus, typically, be greater in the textured or light-colored areas since the human eye “masks” the differences more in these areas. It is noted that the digital images intended to be printed can be altered so that the modifications are visible and disturbing on the digital image, whereas they will become invisible or less disturbing once printed. Therefore, assume that, for a grey-scale or color digital image constituted of N pixels, a masking model makes it possible to derive the quantity by which, in each pixel, the grey-scale or color can be modified in an acceptable way with regard to the application. It is pointed out that a frequential masking model can easily be adapted by the person in the field for deducing spatial masking values. In addition, assume that there is a spatial digital watermark model, in which the image is divided into blocks of pixels of identical size, and a message element is inserted into it, for example one watermark bit in each block by increasing or decreasing the grey-scale or color value of each pixel, up to the maximum or minimum allowed, the increase or decrease made according to the inserted bit. It is noted that the watermark bits can for example be the equivalent of a SIM's scrambled message.

You want to determine whether a captured image represents an original or a copy, on the basis of the message's error rate, measured by the number of elements of the message incorrectly detected. It is noted that, for this, the message must have been read correctly, which assumes the insertion of a sufficient number of redundancies of the message.

Many ways are known from the prior state of art for measuring the value of a bit stored in a block of the image, using for example a high-pass or band-pass filter, a normalization of the values over the image or by area. As a general rule, a non-binary value, continuous, positive or negative even, is obtained. This value can be thresholded in order to determine the most probable bit, and by comparing with the inserted bit the error rate is measured. You can also retain the values and measure a correlation index, from which an error rate is derived as seen previously.

It is also noted that the message's error rate can be measured indirectly by the method for determining copies without reading the message described elsewhere.

It is clear to the person in the field that the greater the size of the blocks, in pixels, the lower the message's error rate. On the other hand, the message's redundancy will be lower. Depending on the print quality and resolution, the person in the field will determine the size of the block offering the best compromise between the message's error rate and redundancy, so as to maximize the probability that the message is correctly decoded. On the other hand, the prior state of the art does not cover the problem of the size of the cell with regard to optimizing the detection of copies. Certain aspects of the present invention aim to remedy this problem.

The theoretical model applied previously to determine a DAC's optimal error rate can be applied here. In effect, you can consider each block to be a cell having a probability p of being degraded, and you search for the optimum on p in the case where you have a fixed physical size (in effect, the image to be printed has a fixed size in pixels and a fixed resolution). Here again, you make the approximative hypothesis that the probability p is inversely proportional to the surface area available for a cell. Again it is found that the indicator I is maximized for p=27%. Other models are possible that can lead to different optima.

The following steps can be applied to determine the optimum size of the block for detecting copies:
receive at least one image representing an image used in the application,
by using a masking model, calculate, for each pixel of each image, the maximum difference that can be introduced,
for the various block sizes to be tested, for example 1×1, 2×2, . . . , up to 16×16 pixels per block, generate at least one message of a size corresponding to the number of blocks of the image,
insert each of the messages corresponding to each of the block sizes in each of the images, to obtain the marked images,
print, at least once, each of the images marked under the print conditions of the application,
capture, at least once, each of the marked images,
read the watermark and determine the error rate for each of the captured images,
group the measured error rates by block size, and calculate the average error rate for each block size and
determine the block size for which the average error rate is the closest to the target error rate, for example 27%.

A method for optimizing print parameters for AMSMs is described below.

The AMSM is comprised of dots distributed pseudo-randomly with a certain density, low enough to be difficult to locate, for example with a density of 1%. A score relating to the peak of cross-correlation between the reference AMSM and the captured AMSM corresponds to the signal's energy level, and with theoretically be lower for the copies. It is stated that if the copy is “slavish”, for example a photocopy, the probabilities are high that a large number of dots already weakened by the first printing will disappear completely when the copy is printed: it is therefore very easy to detect the copy when the signal's energy level is much weaker. On the other hand, if before printing the copy you apply intelligent image processing intended to identify the dots and restore them to their initial energy, this latter would have a noticeably greater energy level and score.

In order to reduce this risk and maximize the difference in score between the copies and the originals, they should be printed at a resolution or size of dots that maximizes the difference in energy levels. However, the prior state of the art does not cover this problem, and the AMSMs are often created in a sub-optimum way with regard to detecting copies.

Simple reasoning enables the conclusion that, ideally, the dots of the AMSM should have a size such that about 50% of them will “disappear” during the initial printing. “Disappear”, as understood here, signifies that an algorithm seeking to locate and reconstruct the dots will only be able to correctly detect 50% of the initial dots.

In effect, assume that on average a percentage p of dots disappear when an original is printed. If the copy is done under the same print conditions, a percentage p of the remaining dots will also disappear: as a result, the percentage of disappeared dots will therefore be p+p*(1−p):

By applying the criteria used previously, in which you seek to maximize the variance between the originals and the copies, normalized by the standard deviation of the originals, which is p*(1−p), you thus want to maximize the criterion C below according to p, where N is the fixed number of AMSM dots:

C =\sqrt{N·p·(1−p)}

It is ascertained that C is maximized for p=0.5.

The above model applies in cases where the number of dots is fixed. On the other hand, if you want a fixed pixel density (for example 1% of pixels marked), you will be able to use a larger number N of dots for a given density if the dots comprise fewer pixels. If you define the density d and the number of pixels per dot m, you have the relationship:

$$N = \frac{1}{d \cdot m}$$

By making the hypothesis that the probability that a dot disappears can be approximated as proportional to the inverse of the dot's size in pixels, you have:

$$p = \frac{a}{m}$$

where “a” is a constant.

Thus C is expressed as a function of p, d, a and m:

$$C = \frac{\sqrt{{p}^{2} \cdot ( 1 - p )}}{d \cdot a}$$

It is ascertained that, d and a being constants for a given application, C is maximized for p=⅔ or 66.6%.

For implementation, you can utilize the following steps:
for a fixed density (of black pixels), print AMSMs with dots of different sizes (for example, 1×1, 1×2, 2×2, etc),
capture at least one image for each of the different AMSMs,
determine the number of dots correctly identified for each AMSM, and measure the error rate and
select the parameters corresponding to the AMSM having the error rate closest to the optimum error rate for the criterion selected, for example 50% or 66%.

It is noted that, if the AMSM bears a message, the error-control codes must be adjusted to this high error rate. It is also noted that, if the detector is based on an overall energy level, the copy's score may be artificially increased by printing the correctly located dots so that they contribute in a maximum way to the measurement of the signal's energy. Finally, other criteria for determining the optimum are possible, taking into account, for example, the density of the dots, the number of pixels of discrepancies in position, shape or size, of the number of correctly colored pixels in each cell, etc.

It is noted that similar processing can be carried out for the VCDPs, it being understood that the cells affected with print or copy errors do not necessarily change appearance between presence and absence, but their positions, sizes or shapes, variable according to the information represented, can also be modified by these errors.

A VCDP (acronym for “Variable Characteristic Dot Matrix”) is produced by generating a dot distribution so that:
at least half the dots of said distribution are not laterally juxtaposed to four other dots of said dot distribution, and
at least one dimension of at least one part of the dots of said dot distribution is of the same order of magnitude as the average for the absolute value of said unpredictable variation.

This thus makes it possible to exploit the individual geometrical characteristics of the marked dots, and to measure the variations in the characteristics of these dots so as to integrate them in a metric (i.e. determine whether they satisfy at least one criterion applied to a measurement) allowing the originals to be distinguished from copies or non-legitimate prints.

For preference, for the dot distribution, more than half the dots do not touch any other dot of said distribution. Thus, unlike secured information matrices and copy detection patterns, and like AMSMs and digital watermarks, it allows invisible or unobtrusive marks to be inserted. In addition, these marks are easier to integrate than digital watermarks and AMSMs. They enable a more reliable way of detecting copies than digital watermarks and they can be characterized individually in a static print process, which allows each document to be uniquely identified.

In embodiments, dots are produced of which at least one geometric characteristic is variable, the geometric amplitude of the generated variation being of the order of magnitude of the average dimension of at least one part of the dots. This therefore makes it possible to generate and use in an optimal way images of variable characteristic dot patterns, also called “VCDPs” below, designed to make copying by identical reconstitution more difficult, even impossible.

According to embodiments, the variation generated corresponds to:
a variation in the position of dots, in at least one direction, with respect to a position where the centers of the dots are aligned on parallel lines perpendicular to said direction and separated from at least one dimension of said dots in that direction; it thus makes it possible to exploit the precise position characteristics of the dots, and to measure the very small variations in the precise position of the dots so as to integrate them in a metric allowing the originals to be distinguished from copies;
a variation in at least one dimension of dots, in at least one direction, with respect to an average dimension of said dots in that direction;
a variation in the shape of the dots with respect to an average shape of said dots in that direction.

The dot distribution can be representative of a coded item of information, thus allowing information to be stored or carried in the variable characteristic dot distribution. For an equal quantity of information content, the dot distributions can cover a significantly smaller surface area than AMSMs, for example several square millimeters, which allows their high-resolution capture by portable capture tools, and consequently great precision in reading.

Below is a description of how, by measuring the message's error quantity, you can make a decision concerning the document's authenticity according to said error quantity. For that, it is, in theory, necessary to decode said message, since if the message is unreadable, you cannot determine the errors with which it is affected. Nevertheless, if the marking has significantly degraded the message (which is especially the case with copies), or if a large quantity of information is carried, the message might not be readable, in which case an error rate cannot be measured. It would be desirable to be able to measure the error quantity without having to decode said message.

Secondly, the step decoding the message utilizes algorithms that can turn out to be costly. If you only want to authenticate the message, not read it, the decoding operation is only performed for the purpose of measuring the error rate; eliminating this step would be preferable. In addition, if you want to make a finer analysis of the error rate, you need to reconstruct the replicated message. This reconstruction of the original replicated message can turn out to be costly, and it would be preferable to avoid it.

However, at the origin of one of the aspects the present invention, it was discovered that, for the purpose of measuring an error quantity, it is not, paradoxically, necessary to reconstitute the original replicated message, or even to decode the message. In effect, a message's error quantity can be measured by exploiting certain properties of the message itself, at the time of the encrypted message's estimation.

Take the case of a binary message. The encoded message is comprised of a series of bits that are replicated, then scrambled, and the scrambled message is used to constitute the SIM. The scrambling comprises, as a general rule, a swap, and optionally the application of an “exclusive or” function, and generally depends on one or more keys. Thus, each bit of the message can be represented several times in the matrix. In the example given with regard to FIGS. 1 to 5B, a bit is repeated 35 or 36 times. During the step accumulating the encoded message, all the indicators of the value of each bit or element of the message are accumulated. The statistical uncertainty of the bit's value is generally significantly reduced by this operation. This estimate, which is considered to be the correct value of the bit, can therefore be used in order to measure the error quantity. In effect, if the marked matrix comprises relatively few errors, these will basically all be corrected during the accumulation step, and thus it is not necessary to reconstruct the encoded message for which you already have a version without errors. In addition, if some bits of the encoded message have been badly estimated, in general the badly estimated bits will have a reduced impact on the measurement of the error quantity.

An algorithm is given below for steps measuring the error quantity without decoding the message, for binary data.
for each bit of the encoded message, accumulate the values of the indicators,
determine, by thresholding, the (most probable) value of the bit (“1” or “0”); the most probable estimate of the encoded message is obtained and
count the number of indicators (for each cell, the density, or normalized value of luminance) that correspond to the estimate of the bit of the corresponding encoded message.

In this way you can measure an integer number of errors, or a rate or percentage of erroneous bits.

Alternative to this last step, you can retain the value of the indicator and measure a global index of similarity between the values of the indicators and the corresponding estimated bits of the encoded message. An index of similarity may be the coefficient of correlation, for example.

In a variant, a weight or coefficient can be associated, indicating the probability that each estimated bit of the encrypted message is correctly estimated. This weight is used to weight the contributions of each indicator according to the probability that the associated bit is correctly estimated. A simple way to implement this approach consists of not thresholding the accumulations corresponding to each bit of the encoded message.

It is noted that the noisier the message is, the higher the risk that the estimated bit of the encrypted message is erroneous. This gives rise to a bias such that the measurement of the error quantity under-estimates the actual error quantity. This bias can be estimated statistically and corrected when the error quantity is measured.

It is interesting to observe that, with this new approach to measuring the error quantity, a SIM can be authenticated without needing to know, directly or indirectly, the messages needed for its conception. You simply have to know the groupings of cells that share common properties.

In variants, several sets of indicators are obtained, coming from different pre-processing operations applied to the image (for example, a histogram transformation), or from reading at different positions of the SIM; an error quantity is calculated for each set of indicators, and the lowest error rate is retained; in order to speed up the calculations, the estimation of the encoded message can be done only once (the probability is low of this estimation changing for each set of indicators).

It can be considered that images (or matrices) are generated whose sub-sections share common properties. In the simplest case, sub-groups of cells or pixels have the same value, and they are distributed pseudo-randomly in the image according to a key. The property in question does not need to be known. On reading, you do not need to know this property, since you can estimate it. Thus, the measurement of a score allowing the authenticity to be indicated does not need a reference to the original image, or a determination of a message. Therefore, in embodiments, the following steps are utilized for document authentication:
a step of receiving a set of sub-groups of image elements (for example, values of pixels), each sub-group of image elements sharing the same characteristic, said characteristics not necessarily known,
an image capture step,
a step of measuring characteristics of each image element,
a step of estimating characteristics common to each sub-group of image elements,
a step of measuring the correspondence between said estimates of the characteristics common to each sub-group, and said measured characteristics of each of the image elements and
a step of deciding on the authenticity, according to said measurement of correspondence.

In other embodiments, which are now going to be described, it is not necessary to know or reconstruct the original image, nor to decode the message that it bears, in order to authenticate a DAC. In fact, you just need, on creation, to create an image comprised of sub-sets of pixels that have the same value. On detection, you just need to know the positions of the pixels that belong to each of the sub-sets. The property, for example the value of pixels belonging to the same sub-set, does not have to be known: it can be found during reading without needing to decode the message. Even if the property is not found correctly, the DAC can still be authenticated. We call this new type of DAC “random authentication pattern” (“RAP”) below. The word ‘random’ signifies that, inside a given set of possible values, the RAP can take any of its values whatsoever, without the value being stored after the image creation.

For example, assume that there is a DAC comprised of 12,100 pixels, i.e. a square of 110×110 pixels. These 12,100 pixels can be divided into 110 sub-sets each having 110 pixels, such that each pixel is located in exactly one sub-set. The division of the pixels into sub-sets is done pseudo-randomly, for preference with the help of a cryptographic key, such that without the key it is not possible to know the positions of the different pixels belonging to a sub-set.

Once the 110 sub-sets have been determined, a random or pseudo-random value is assigned to the pixels of each sub-set. For example, for binary pixel values the value “1” or the value “0” can be assigned to the pixels of each sub-set, for a total of 110 values. In the case of values determined randomly, 110 bits are generated with a random generator, these 110 bits able to be subsequently stored or not. It is noted that there are 2¹¹⁰ possible RAPs for a given sub-set division. In the case of values generated pseudo-randomly, a pseudo-random number generator is used to which a cryptographic key is supplied, generally stored subsequently. It is pointed out that for such a generator based on the SHA1 hash function the key is 160 bits, whereas you must only generate 110 bits in our example. Thus the use of the generator can have a limited use.

Knowing the value of each of the pixels, you can then assemble an image, in our case of 110×110 pixels. The image can be a simple square, with the addition of a black border making its detection easier, or can have an arbitrary shape, contain microtext, etc. Groups of pixels with known values serving for a precise image alignment can also be used.

The image is marked in such a way as to optimize its degree of degradation, according to the marking quality, itself dependent on the substrate quality, the precision of the marking machine and its settings. Methods are given below for this. Detection from a captured image of a RAP is carried out as follows. Methods of processing and recognizing images, known to the person in the field, are applied so as to locate the pattern in the captured image with precision. Then, the values of each pixel of the RAP are measured (often on a scale of 256 levels of grey). For convenience and the uniformity of the calculations, they can be normalized, for example on a scale of −1 to +1. They are then grouped together by corresponding sub-set, in our example to sub-sets of 110 pixels.

Thus, for a sub-set of pixels having, at the beginning, a given value, you will have 110 values. If the value of the original pixels (on a binary scale) was “0”, the negative values (on a scale of −1 to +1) should dominate, while the positive values should dominate if the value was “1”. You will therefore be able to assign a value of “1” or “0” to the 110 pixels, and for each of the 110 sub-sets.

For each of the 12,100 pixels, we have a measured value in the image, possibly normalized, and an estimated original value. An error quantity can thus be measured, for example by counting the number of pixels that coincide with their estimated value (i.e. if the values are normalized over −1 to +1, respectively a negative value coincides with “0” and a positive value with “1”). You can thus measure an index of correlation, etc.

The score (“score” signifying an error rate or a similarity) found is then compared to a threshold to determine whether the captured image corresponds to an original or a copy. Standard statistical methods can be used to determine this threshold.

It is noted that the procedure described does not use data outside the image, except for the composition of the sub-sets, to determine a score. Therefore, the count of the error quantity can be expressed thus.

The error quantity is equal to the sum, over the sub-sets, of (Sum(Sign(zij)==f(zi1, . . . , ziM))).

where zᵢⱼ is the value (possibly normalized) of the ith pixel of the jth sub-set comprising M elements and

f is a function estimating a pixel value for the sub-set, for example f(zᵢ₁, . . . , z_{iM})=Sign(zᵢ₁+ . . . +z_{iM}).

Several variants are possible:
a cryptographic key is used to scramble the values of the pixels of the same sub-set, so that they do not all have the same value. The scrambling function can be the “exclusive or” function.
the function calculating a score can estimate and integrate a probability that the value of the pixel is respectively “1” and “0” (for binary pixel values).
the method described can be applied to other types of DAC if their construction is suitable for this (in particular for SIMs, with the previously mentioned advantages),
the method described can be extended to non-binary pixel values and/or
the values of a sub-set's pixels can be determined so as to carry a message (without this inevitably needing to be decoded on reading).

The reading of a DAC requires the latter to be precisely positioned in the image captured, so that the value of each of the cells composing it is reconstructed with the greatest possible fidelity taking into account the degradations caused by the printing and possibly by the capture. However, the captured images often contain symbols that can interfere with the positioning step. Clearly, the smaller the surface area occupied by the SIM, the greater the probability that other symbols or patterns interfere with the positioning step. For example, an input of the size of an A4 page, for example a folder containing a SIM, will contain a large number of other elements. However, even relatively small-sized captures, for example 1.5 by 1.1 cm, can contain symbols that can be confused with a SIM, such as a black square, a DataMatrix, etc (see FIG. 6).

Locating a SIM can be made more difficult by the capture conditions (poor lighting, blurring, etc), and also by the arbitrary orientation of position over 360 degrees.

Unlike other 2D bar code types of symbols, which vary relatively little with various types of printing, the DAC's characteristics (for example texture) are extremely variable. Thus the prior state of the art methods, such as those presented in document U.S. Pat. No. 6,775,409, are not applicable. In effect, this latter method is based on the directionality of the luminance gradient for detecting codes; however, for SIMs the gradient has no particular direction.

Certain methods of locating DACs can benefit from the fact that these latter appear in square or rectangular shapes, which gives rise to a marked contrast over continuous segments, which can be detected and used by standard image processing methods. However, in certain cases, these methods are unsuccessful and, secondly, you want to be able to use DACs that are not necessarily (or are not necessarily inscribed in) a square or rectangle.

In a general way, a DAC's printed surface area contains a high ink density. However, while exploiting the measurement of ink density is useful, it cannot be the only criterion: in effect, Datamatrixes or other bar codes often adjacent to the DACs have an even higher ink density. This single criterion is not, therefore, sufficient.

Exploiting the high entropy of CDPs to determine the portions of images belonging to CDPs, has been suggested in document EP 1 801 692. However, while CDCs, before printing, have an entropy that is indeed high, this entropy can be greatly altered by printing, capture and by the calculation method used. For example, a simple measurement of entropy based on the histogram spread of the pixel values of each area can sometimes lead to higher indicators over regions not very rich in content, which, in theory, should have a low entropy: that may be due, for example, to JPEG compression artifacts, or to the texture of the paper that is preserved in the captured image, or to reflection effects of the substrate. Therefore, it is seen that the entropy criterion is insufficient as well.

More generally, the methods of measuring or characterizing textures appear more appropriate, so as to characterize, at the same time, the intensity properties or the spatial relationships specific to the textures of the DACs. For example, in “Statistical and structural approaches to texture”, included here as reference, Haralick describes many texture characterization measurements, which can be combined so as to uniquely describe a large number of textures.

However, the DACs can have textures that vary enormously depending on the type of printing or capture, and in general it is not possible or, at least, not very practical, to provide the texture characteristics to the DAC location module, all the more so because these must be adjusted depending on effects specific to the capture tool on the texture measurements.

It therefore appears that, in order to locate a DAC in a reliable way, a multiplicity of criteria must be integrated in a non-rigid way. In particular, the following criteria are appropriate:
the DAC texture: DACs will generally have a greater level of inking and a greater contrast than their surroundings. Note that this criterion on its own may not be sufficiently distinctive: for example there may not be a great contrast for certain DACs saturated with ink,
DACs have a great contrast at their edge: generally a non-marked silent area surrounds the DAC, which itself can be surrounded by a border in order to maximize the contrast effect (note that certain DACs do not have a border, or only a partial border),
DACs often have a specific shape, square, rectangular, circular or other, which can be used for location and
in their internal structure, DACs often have fixed data sets, known provided you possess the cryptographic key or keys that were used to generate them, generally serving for fine synchronization. If these data sets are not detected, this indicates that either the SIM has not been located correctly, or the synchronization data sets are not known.

These four criteria, which are the overall texture characteristics of the DACs, the characteristics at the edges of the DACs, the general shape, and the internal structure, can, if they are suitably combined, allow the DACs to be located with great reliability in environments known as “hostile” (presence of other two-dimensional codes, poor capture quality, locally variable image characteristics, etc).

The following method is proposed in order to locate the DACs. It will be recognized that many variants are possible without departing from the spirit of the method . . . It applies to square or rectangular DACs, but can be generalized to other types of shapes:
divide the image into areas of the same size, the size of the areas being such that the surface area of the DAC corresponds to a sufficient number of areas;
measure, for each area, a texture indicator. The indicator can be multi-dimensional, and for preference comprise a quantity indicating the level of inking and a quantity indicating the local dynamic;
possibly, calculate for each area a global texture indicator, for example in the form of a weighted sum of each indicator measured for the area;
determine one or more detection thresholds, depending on whether you have retained just one or several indicators per area. Generally, a value greater than the threshold suggests that the corresponding area forms part of the DAC. For the images presenting illumination deviations, a variable threshold value can be applied. When several indicators are retained, you can require all the indicators to be greater than their respective threshold for the area to be considered to form part of the DAC, or solely one of the indicators to be greater than its respective threshold;
determine the areas that belong to the DAC, known as “positive areas” (and the inverse “negative areas”). A binary image is obtained. In an option, apply a cleaning by successively applying expansion and erosion, for example by following the methods described in chapter 9 of the book “Digital Image Processing using Matlab” by Gonzales, Woods and Eddin;
determine the continuous clusters of positive areas, of a size greater than a minimum area. If no continuous cluster is detected, go back to the second step of this algorithm and reduce the threshold until at least one continuous cluster of minimum size is detected. In a variant, vary the selection criteria of the areas if each area has several texture indicators. Determine the areas tracing the contour of the cluster, which are on the DAC's border, characterized by the fact that they have at least one negative neighboring area;
for detecting a square, determine the two pairs of dots formed of the farthest apart dots. If the two corresponding segments have the same length, and if they form an angle of 90 degrees, it is deduced that they form a square. In a variant, apply the Hough transform;
in a variant, apply a limit detection filter to the original image or to a reduced version of it. (see chapter 10 of the same book for examples of filters) and
determine a threshold, then the positions of the pixels having a response to the filter that is greater than the threshold. These pixels indicate the limits of objects, especially the limits of the area of the SIM. Verify that the areas in the edges of the DAC determined in four contain a minimum number of pixels indicating the object limits.

With regard to the step dividing the image into areas, the size of the areas has what can be a significant influence on the location result. If the areas are too small, the indicators measured will be imprecise and/or very noisy, which makes it difficult to detect areas belonging to the DAC. If, on the other hand, they are too large, the location of the DAC will be imprecise, and it will be difficult to determine that the shape of an inferred DAC corresponding to the shape searched for (for example a square). Moreover, the sizes of the areas should be adjusted according to the surface area of the DAC in the captured image, which can be known but does not necessarily have to be. For certain capture tools, the images will be of fixed size, for example 640×480 pixels is a format frequently encountered. Theoretically, therefore, the capture resolution will not be very variable. Certain capture tools will be able to support more than one image format, for example 640×480 and 1,280×1,024. The size of the area will therefore need to be adjusted according to the resolution. For example, for a capture tool producing images with a format of 640×480, with capture resolution equivalent to 1,200 dpi (dots per inch), the image can therefore be divided into areas of 10×10 pixels, for a total of 64×48 areas. If the same tool also supports a format of 1,280×1,024, resulting in the capture resolution being doubled to 2,400 dpi, the size of the area will also be doubled to 20×20 pixels (the pixels on the edges that do not form a complete area may be left on one side). For images coming from a scanner, whose resolution is not always known, you may assume a capture resolution of 1,200 dpi, or determine it based on the meta-data.

It is noted that it is possible to use areas with the size of one pixel, subject to eliminating or controlling the highest noise risks in the following steps.

With regard to measuring a texture indicator, as described above, as the texture of the DACs can vary significantly, there is no ideal measurement of the texture indicator. Nevertheless, the DACs are generally characterized by a heavy level of inking and/or great variations. If the ink used is black or dark, and the pixels have values ranging from 0 to 255, you can take yi=255−xi as the value for the ith pixel of an area. The indicator of the area's inking level can therefore be the average of the yi. However, you can also take the median, the lowest value, or a percentile (in a histogram, the position/value in the histogram that corresponds to a given percentage of the samples) of the sample of values. These latter values can be more stable, or more representative, that a simple average.

As an indicator of variations, you can measure the gradient in each dot, and retain the absolute value.

As a combined texture indicator, you can add, in an equal proportion or not, the indicator of the level of inking and the indicator of variations. As these indicators are not to the same scale, you may initially calculate the indicators of the level of inking and variations of all the areas of the image, normalize them so that each indicator has the same maximums/minimums, then add them to obtain the combined texture indicators.

With regard to determining the detection threshold, it is noted that it is very tricky. In effect, if this threshold is too high, many areas belonging to the DAC are not detected as such. On the other hand, too low a threshold will lead to the false detection of a significant number of areas not belonging to a DAC.

FIG. 14 represents an information matrix 665 captured with an angle of about 30 degrees and a resolution of about 2,000 dpi. FIG. 15 represents a measurement 670 of a combined texture indicator (106×85) performed on the image from FIG. 14. FIG. 16 represents the image from FIG. 15, after thresholding, i.e. after comparison with a threshold value, forming image 680. FIG. 17 represents the image from FIG. 16 after applying at least one expansion and one erosion, forming image 685. FIG. 18 represents an information matrix contour 690, a contour determined by processing the image from FIG. 17. FIG. 19 represents corners 695 of the contour illustrated in FIG. 18, determined by processing the image from FIG. 18.

What makes determining threshold difficult is that the properties of the images vary significantly. In addition, the images can have texture properties that change locally. For example, because of the lighting conditions the right side of the image may be darker than its left side, and the same threshold applied to the two sides will result in many detection errors.

The following algorithm offers a certain robustness to variations in texture, by dividing the image into four areas and adapting the detection thresholds to the four areas.

Determine the indicator's 10^{th} and 90^{th} percentile (or first and last deciles) for the whole image. For example, 44 and 176. Determine a first threshold mid-way between these two thresholds: (176+44)/2=110. By dividing the matrix of the areas into four equal-sized areas (for example, 32×24 for a size of 64×48), calculate the 10^{th} percentile for each of the four areas, for example 42, 46, 43 and 57.

Below is described a method of local segmentation (“adaptive thresholding”). Some captured DACs have a low contrast with the frontiers, or present illumination variations that can be such that some parts of the DAC can be lighter than the background (which, in theory, must not be the case for a DAC printed in black on a white background). In this case, quite simply there is no global threshold that allows correct segmentation, or at least this cannot be determined by standard methods.

To solve this type of problem, you have recourse to the following algorithm making it possible to determine the areas presenting a predefined uniformity of score. For example, you determine the area to be segmented beginning with a starting dot (or area), then iteratively selecting all the adjacent areas presenting a criterion of similarity. Often, this starting dot will be selected because it contains an extreme value, for example the lowest score for the image. For example, if the starting dot has a (minimum) score of X, and the criterion of similarity consists of all the areas falling in a range X to X+A, A being a pre-calculated positive value, for example according to measurements of the image's dynamic, the set of adjacent cells satisfying this criterion are selected iteratively.

If this method fails, an alternative method consists of determining the areas that do not present a sudden transition. The method also consists of finding a starting dot with score X, then selecting an adjacent dot Pa if its score Y is less than X+B (B also being a predefined value). Then, if this adjacent dot Pa is selected, the selection criterion for the dots adjacent to Pa is modified to Y+B.

It is noted that these algorithms can be applied several times to the image, for example by taking different starting dots on each iteration. In this way, you can obtain several candidate areas, some of which can overlap.

With regard to classifying areas according to the calculated threshold, similar approaches can be used to determine a global threshold, such as the iterative method described on pages 405 to 407 of the book “Digital Image Processing using Matlab” (Gonzales, Woods and Eddin).

With regard to refining the areas relating to the DAC, border areas can be determined by selecting the areas for which at least one adjacent area does not respond to the criterion for the areas (texture indicator greater than the detection threshold).

When you have determined one or more candidate areas, you must still determine whether the areas have a shape corresponding to the shape searched for. For example, a large number of DACs have square shapes, but this can be rectangular, circular, etc. A “signature” of the sought-for shape can thus be determined, by determining the original shape's barycenter, then calculating the distance between the barycenter and the most distant extremity of the shape according to each degree of angle, scanning the angles from 0 to 360 degrees. In this way, the signature corresponds to the curve representing a distance normalized according to the angle: this curve is constant for a circle, comprises four extrema of the same value for a square, etc.

For a candidate area, the signature is also calculated. Then this signature is matched to the original signature, for example by measuring the autocorrelation peak (to take account of a possible rotation). Re-sampling the original or calculated signature may also be necessary. If the calculated value of similarity is greater than a predetermined threshold the area is retained, otherwise it is rejected. If you search for areas comprising extrema, for example a square, it can subsequently be useful to determine the corners of the square from the dots associated to the extrema.

The steps utilized can be the following:
receive an original signature, and a data representation describing a candidate area,
calculate the signature of the candidate area,
measure the maximum value of similarity between the candidate signature and the original signature and
retain the candidate area if this value of similarity is greater than a threshold and, optionally, determine the dots corresponding to the extrema of the signature candidate.

A method for the conception of SIMs that are not very sensitive to the level of inking is now going to be described. As has been seen, excessive inking of the SIM can significantly reduce its readability, and even its ability to be distinguished from one of its copies. However, while means exist for controlling as far as possible the level of inking on printing, they can be difficult, even impossible, to utilize. It would be preferable to have SIMs that are robust to a wide range of levels of inking.

It turns out that the SIMs are generally more sensitive to a high level of inking than a low level of inking. In effect, when the level of inking is low, the black cells (or the cells containing color) are generally always printed, and thus reading the matrix is not much affected by this. In contrast, as image 515 of FIG. 6 shows, when the level of inking is too high the ink tends to saturate the substrate, and the white areas are to some extent “flooded” by the ink from the surrounding black areas. A similar effect can be observed for marking by means of contact, laser engraving, etc.

The asymmetry between the penalizing effect of excessive inking with respect to the effect of insufficient inking leads to the thought that SIMs comprising lower proportion of marked pixels will be more robust to variations in levels of inking. However, the values of the cells are generally equiprobable, this being caused by the encryption and scrambling algorithms that maximize the matrix's entropy. For binary matrices containing black or white cells, you can always reduce the number of black pixels that constitute a black cell. For example, if the cell is 4×4 pixels, you can choose to only print a square sub-set of it of 3×3 pixels, or 2×2 pixels. The inking is therefore reduced respectively by a ratio of 9/16 and 1/4 (it is noted that the white cells are not affected). Other configurations are possible. For example, as illustrated in FIG. 12. FIG. 12 shows:
a SIM 585 for which the cells are 4×4 pixels and the printed area of each cell is 4×4 pixels, surrounding a VCDP 575 and surrounded by microtext 580,
a SIM 600 for which the cells are 4×4 pixels and the printed area of each cell is 3×3 pixels, surrounding a VCDP 590 and surrounded by microtext 595,
a SIM 615 for which the cells are 3×3 pixels and the printed area of each cell is 3×3 pixels, surrounding a VCDP 605 and surrounded by microtext 610,
a SIM 630 for which the cells are 3×3 pixels and the printed area of each cell forms a cross of 5 pixels, surrounding a VCDP 620 and surrounded by microtext 625 and
a SIM 645 for which the cells are 3×3 pixels and the printed area of each cell is 2×2 pixels, surrounding a VCDP 635 and surrounded by microtext 640.

You could also print areas of 2×2 or 1×1 pixels on cells whose dimensions are 4 or 2 pixels, for example. Clearly, asymmetric or variable configurations are also possible, in which the variability can perform other functions such as storing a message or reference for the purposes of authentication, as illustrated in FIG. 11, below.

In this last case, the added message can be protected against errors and secured in a similar way to the other messages inserted in the SIMs. Only, the modulation will differ. Take an example: a SIM containing 10,000 cells, carrying a message, will have on average 5000 black cells. However, the exact number will differ for each message or encryption and scrambling keys. You therefore first need to generate the SIM as you would do with full cells, in order to know the exact number of pixels available (which, it is recalled, has a direct impact on the swap that will be applied). Thus assume that in a specific case, the SIM numbers 4980 black cells. If the cells have 4×4 pixels, there will be 4,980*16=79,680 pixels available. If you want to insert an 8-byte message, which might total 176 bits once transformed into convolutional code with a rate of 2 and a memory of 8, the message can be replicated 452 times (and, partially, a 453^{rd} time). The replicated message will be scrambled (i.e. swapped and passed through an “exclusive OR” function). A method is presented later for minimizing the cost of the swapping. The scrambled message will be modulated in the SIM's black cells.

FIG. 11 shows, at the bottom, an example of the result 570 of this modulation, compared to a SIM 565 with black cells that are “full”, in the top of FIG. 11.

It is noted that with this method you have, statistically, 50% of the pixels of the black cells that will be inked, and therefore a reduction in the level of inking by a factor of ½. It may be easy to vary this level of reduction in the inking, for example by reserving a certain number of pixels per cells that will have a predefined value, black or white. With a minimum number having a black color, you avoid accidently having a “black” cell with no black pixels.

This second level of message is very advantageous. As it is at a higher resolution, it comprises a larger number of errors, but redundancy is higher (8 times higher for cells of 4×4 pixels), allowing this higher number of errors to be compensated for. It is much more difficult to copy, since it is at very high resolution, and its presence can even be undetectable. The message or messages contained can be encrypted and scrambled with different keys, which means a greater number of security levels can be managed.

A large number of other variants are possible, for example dividing a 4×4 cell into four 2×2 areas: the level of inking will be the same statistically, on the other hand the resolution will be lower and the message will bear fewer errors, but will also have a lower level of redundancy.

A SIM can also contain several areas where the densities of the cells vary, such that at least one of the densities is suitable with respect to the level of inking on printing. In this case, the reading can be performed by favoring the areas having the most suitable level of inking.

A combined method for optimizing the size of the cells and the density of the level of inking for the cells is described below: you test several size/inking pairs, you select, for example, those that fall within the 19-27% error range. If several pairs are selected, you select those that relate to the highest resolution.

With regard to the rate, or proportion, of errors, this can be defined as Error Rate=(1−corr)/2, where corr is a measurement corresponding to the correlation between the message received and the original message, over a range of −1 to 1 (in practice the negative values are not very probable). Thus, for corr=0.75 you have an error rate of 0.125 or 12.5%. It is noted that in this case the term “correlation” signifies “having the same value”. It is also noted that the term error used here relates to print errors, errors due to the degradation of the information matrix during the document's life and errors reading the values of the matrix's cells and, where appropriate, copy errors. In order to minimize this third term (reading errors), for preference several successive reading operations are performed and the one presenting the lowest error rate is retained.

Otherwise, in order to measure the error rate the image can be thresholded in an adaptive way, values greater/less than the threshold being thresholded to white/black. Adaptive thresholding allows more information to be preserved, the thresholded image generally presenting more variability than if it had been globally thresholded. To apply adaptive thresholding, you can, for example, calculate an average threshold for the image and apply a local bias according to the average luminance of a 10×10 pixel frame. Alternatively you can apply a high-pass filter to the image, then a global filter, for an effect. To determine the error rate in the case where the image has been thresholded, you simply count the number of cells whose thresholded value does not correspond to the expected value.

In the case where the generation, printing and/or reading are performed taking into account the levels of grey, each cell has an individual error rate and the correlation utilizes this individual error rate of the cells.

It is recalled that, to maximize the probability of detecting copies, the SIMs must be printed at the closest possible print resolution to the degradation optimum. However this latter differs depending on whether the constraint used in the model is a fixed physical size or a fixed number of cells. Yet for a given cell size, or resolution, the density of the cells can have a strong impact on the degradation rate. Thus the cell density giving the lowest error rate for a given cell size is favored, even if there is a density giving an error rate closer to the optimum. In effect, with regard to the inking density, it is preferable to be positioned in the print conditions giving the best print quality, such that if counterfeiters use the same print procedure they cannot print copies with a better quality than the originals.

In the following example we have created six SIMs with an identical number of cells (therefore with different physical sizes), with six sets of cell size/density values: The SIMs have been offset printed for a plate resolution of 2,400 ppi, then read with a flatbed scanner at 2,400 dpi, giving a good-quality image so as to minimize the reading errors caused by capturing the image. The following table summarizes the average error rates obtained for the various parameters, the minimum error rate obtained (MIN) for each cell size, the corresponding density DMIN, and the difference DIFF between this value MIN and the theoretical optimum error rate of 19% for the fixed cell number criterion. It is noted that the boxes not filled correspond to impossible parameter combinations, namely a density greater than the cell size. It is also noted that the density “1”, i.e. a single pixel being printed in each cell, has not been tested, even though this can sometimes give good results.

The following table summarizes the results, the numbers indicated in the lines and columns being the dimensions of the cell sizes (columns) and inked square areas inside the cells (lines); thus the intersection of line “3” with column “4” corresponds to the case where solely a square of 3×3 pixels is printed in the cells of 4×4 pixels to be inked:

| | cell size | | |
|---|---|---|---|
| Density | 2 (1200 ppi) | 3 (800 ppi) | 4 (600 ppi) |
| 2 | 34% | 22% | 12% |
| 3 | — | 26% | 11% |
| 4 | — | — | 22% |
| MIN | 34% | 22% | 11% |
| DMIN | 2 | 2 | 3 |
| DIFF | 15% | 3% | 8% |

It is seen that cell size 3 (column “3”) with density 2 (line “2”) gives the error rate value closest to the optimum of 19%. It is pointed out that the error rate for density 4 and cell size 4 is also 3% from the optimum, but since significantly lower error rates are obtained with densities 2 and 3 (as observed in the intersection of lines “2” and “3” with column “4”), it would not be advantageous to choose these print parameters.

The following steps can be utilized:
create one SIM for each candidate cell size/density pair
print each SIM created, at least once, with the print conditions that will be used subsequently for printing the document, for example three times,
perform at least one capture of at least one print of each SIM created, for example three captures,
calculate the average error rate obtained for each captured SIM,
determine the minimum average error rate obtained MIN for the different SIMs created corresponding to a cell size, and select the associated density, DMIN.
for each MIN, calculate the difference DIFF in absolute value with the optimum and
select the cell size T giving the lowest DIFF value, and the associated density DMIN.

In variants, the cell size being fixed, the density being able to vary OR the cell density being fixed, size being able to vary, you can use the same algorithm, which makes it simpler.

For preference, if they are known, the print characteristics such as the print means, the substrate used, and other print parameters (such as the raster size in offset) can be included in a message carried by the SIM. This information can be used for automatic or human interpretation.

For example, a few bits are generally sufficient for specifying whether the substrate is paper, cardboard, aluminum, PVC, glass, etc. Similarly, a few bits are generally sufficient for specifying whether the print means is offset, typography, screen, gravure printing etc. Thus, if the print means consist of a technique of gravure printing on aluminum, this information is stored in the SIM. In the case where a high-quality copy may have been printed on good paper via offset printing, which may allow the copy to be detected as an original since it is significantly favored from the point of view of the print quality, an operator informed of the expected substrate when the SIM is read can therefore ascertain that the expected substrate does not match.

There are methods of automatically determining the type of printing: for example, offset or laser printing leaves specific traces that can allow the type of printing to be determined automatically based on capturing and processing image(s). The result of applying such a method can be compared automatically to the print parameters as stored in the SIM, and the result can be integrated into the decision concerning the authentication of the document.

Steps for generating and reading/exploiting the information in question are described below, where “print characteristics” can cover a measurement of the level of inking, or the density of the SIM cells (these steps apply to all types of DACs):
automatically measure the print characteristics, over a DAC or an indicator area (see FIGS. 9 and 10), by image processing or using the signal output by a densitometer, for example, or, in a variant, have them entered by an operator,
receive a DAC's print characteristics,
encode the print characteristics, for example in binary or alphanumeric format,
insert the encoded characteristics in the DAC's message and/or in the microtext and
generate the DAC according to a known algorithm.

For exploiting the print characteristics:
automatically measure the print characteristics, over a DAC or an indicator area (see FIGS. 9 and 10), by image processing or using the signal output by a densitometer, for example, or, in a variant, have them entered by an operator,
receive a DAC's print characteristics,
read the DAC,
extract the print characteristics of the message of the DAC read and
compare the extracted characteristics and the characteristics received, and make a decision concerning the nature of the document based on this comparison.

In a variant, the above algorithm is only applied if the DAC is one determined to be original, either automatically or manually.

With regard to measuring print characteristics, other than inking, they are not generally variable over the print channel. The measurement can therefore by performed on indicators not incorporated into the documents but utilized during a phase of testing and calibrating the print channel.

FIG. 13a) represents a SIM 650 comprising 21×21 cells representing a message. FIG. 13b) represents a SIM 655 comprising 21×21 cells representing the same message. FIG. 13c) represents the SIM from FIG. 13b) tiled four times to form a SIM 660.

A preferential embodiment of the information matrices in which a reference of the inking density is inserted will now be described. Printers generally use a densitometer in order to measure the density or level of inking. The densitometer is generally applied on reference rectangles having the maximum amount of ink, placed on the borders of printed sheets, that are discarded when the documents are cut. Often, for a document (or product, packaging, etc) to be printed, the printer receives limit values for the ink density: prints for which the ink density value is outside the permitted range are not valid, and the printer must in theory print them again. If this is not the case, i.e. if the printer has printed the documents without respecting the ink density range for all the samples, it is extremely desirable for this to be able to be detected on the documents in circulation: in effect, the reading can be corrupted (for example, an original can be detected as a copy) if the ink density is too high or too low, and it must be possible to notify the rights holder that there is an ink density problem that is probably the cause of this false reading. This therefore avoids the harmful consequences of a false detection, and can make it possible to hold the printer who has not respected the print parameters responsible. However, as said previously, the reference rectangles have generally been eliminated during cutting.

To measure the ink density suitably, a surface area of approximately four mm² is generally needed, the densitometer's capture diameter being about 1.5 mm². It is advantageous to affix an area of this surface area inside or alongside the SIM, printed with the color used for the SIM, so as to be able to check whether the ink density is suitable in the scenario in which a SIM reading may not give the expected result (for example a copy). FIG. 9 shows a SIM 550 combined with an area of full ink 545 inside the SIM. FIG. 10 shows a SIM 555 combined with an area of ink 560 adjacent to the SIM.

For reading, you can utilize the following steps:
receive the lower and upper ink density bounds,
if necessary, convert these bounds into corresponding grey-scales for the given capture conditions,
input an ink density reference area image,
on the image, determine the grey-scale value of said area and
check whether said value is contained within said bounds: if yes, return a positive message, otherwise a negative message.

A method for generating information matrices comprising geometric patterns, in this case circles, will now be described. An image comprising different geometric patterns is generated, for preference by using a key, and possibly a message. The geometric patterns and their parameters are determined using the key.

The following steps can be utilized for creating the information matrices with geometric patterns:
generate a set of pseudo-random numbers using the key,
generate a blank image,
depending on the numbers generated, determine a set of geometric shapes and their associated parameters,
for each of the geometric shapes determined, insert the geometric shapes into the blank image.

The following steps can be utilized for detecting geometric parameters:
generate a set of pseudo-random numbers using the key,
depending on the numbers generated, determine a set of geometric shapes and their associated parameters, called “original parameters”,
for each of the shapes determined, estimate the parameters of the shape in the image and
measure a distance in a given metric between the estimated parameters and the original parameters of the shape.

A method for integrating variable characteristic dot patterns is described below.

As stated previously, the VCDPs can be used for detecting copies, storing information and for uniquely identifying a single source image. In particular they offer an advantageous and additional means of securing documents. FIG. 7 shows a SIM 520, which comprises a central area in which a VCDP 525 utilizing geometric shapes, in this case circles and microtexts 530, is inserted. FIG. 8 shows a SIM 535 which is surrounded by a VCDP 540. It is noted that, in this case, the elements allowing the DAC to be located, for example its corners, can be used to locate and determine the approximate positions of the dots of the VCDP. FIG. 12 represent VCDPs and SIMs combined.

Integrating a VCDP into a SIM can also increase the level of security, since the counterfeiter must overcome, at the same time, the security barriers against copying the SIM and copying the VCDP. The SIM and VCDP can be created by different cryptographic keys, thus the fact that one key is compromised is not sufficient to compromise all of the graphics. On the other hand, the contained information can be correlated, in such a way that the VCDP and the SIM are intrinsically linked. Here is a possible algorithm:
receive a message, a cryptographic key A for the VCDP, and a key B for the SIM,
create the SIM from the message and key A, reserving a pre-defined space for the VCDP,
determine a second message from the message received, for example a sub-set of this,
create a VCDP from the second message and key B and
insert the VCDP created into the SIM.

In a particular embodiment in which you do not print all the surface area of the cells, for example for reasons of inking density, as described elsewhere, the position of the inked part in the cell is modulated according to a message, possibly random, as with a VCDP. For example, an inked area, represented by a square of 3×3 pixels, in a cell of 4×4 pixels, can take four different positions. In this way, the ability to detect copies and/or embed additional information in the matrix can be increased.

Using an information matrix for unique identification by analyzing the material will now be described. Methods for identifying and authenticating documents based on characterizing the material offer a high level of security. However, these methods can be difficult to utilize since, without marks indicating the area of the document that was used to constitute the imprint, it can be difficult to position the reading tool correctly so that a corresponding part of the document is captured. However, SIMs constitute an easily identifiable reference in order to position the reading tool. Thus, the area located in the centre of the SIM, the position of which can be known with great precision thanks to the SIM's reference patterns, can be used to constitute an imprint of the material. This can be done while preserving this area for inserting a VCDP.

Integrating microtext or text in an information matrix will now be described. Microtext is generally represented in vector form. But the SIMs are pixelized images. As a result, the microtext must be pixelized in order to be incorporated into SIMs. So that the precision of the text is preserved as far as possible, it is preferable to represent the SIM at the maximum resolution possible. For example, a SIM of 110×110 pixels intended to be printed at 600 ppi, should, if the print means allow it, be rescaled to 4 times its size (440×440 pixels), in order to be printed at 2,400 ppi.

SIMs are often equipped with a frame that has a black color or offers a contrast with the immediate surroundings of the matrix, making it easier to detect them in the captured image. However, it turns out that, while the corners of the frame are very useful in practice (determining the positions of each of the corners allows the SIM to be located precisely), the central parts of the frame are not very useful. They can advantageously be replaced by microtext. For example, if the border is 3 pixels for a print at 600 ppi, and therefore 12 pixels for a print at 2,400 ppi, the microtext can be up to 11 pixels high (for preference one pixel is left for the margin with the inside of the matrix).

In the case of a square or rectangular SIM, and if the microtext inscribed on the four sides is identical (for example, the name of the rights holder, the product, etc), it can be advantageous to orient the text in such a way that whatever the orientation in which the SIM is observed or captured, the text can be read normally. FIGS. 7 and 12 illustrate such a matrix.

Areas inside the matrix can also be reserved for inserting microtext. In this case, the SIM creation and reading units must be notified of the areas containing microtext, in order to adjust the modulation and demodulation of the message or messages appropriately.

In the case where the print impression allows the image, and therefore the SIM printed, to be varied on each print (which is in particular possible for digital print means), the microtext can be modified on each print. In this case, the microtext can, for example, contain an identifier, a serial number, a unique number, or any other text, in particular a text allowing the SIM to be linked to the rest of the document. If the document is an identity card, the microtext can, for example, contain the name of its holder. If the document is a package, the microtext can contain the use-by date, the batch number, the brand and product name, etc.

Steps for integrating variable microtext in a SIM are described below:
receive a message, a cryptographic key, possibly a font, areas reserved for the microtext with the associated orientation of the text,
create a SIM image according to the message received and the key, areas reserved,
generate a microtext image according to the message received and
insert the image containing the microtext in each reserved area, possibly by applying a multiple rotation of 90 degrees according to the associated orientation of the text.

In an option, the message used for the microtext is a sub-set of the message received. In another option, the message is encrypted with the key received before generating the microtext.

It is noted that, in a variant, the microtext content is, on printing, a function of the information matrix content or that, inversely, the information matrix content can be a function of the microtext content. The functions in question can be cryptographic functions, for example. For example, the microtext content can, on reading, serve as cryptographic key for determining the information matrix content.

The microtext is, in theory, intended to be read and interpreted by a human being; however, the microtext can also be read automatically by a means of image capture and optical character recognition software. In this case, this software can provide a result in a textual form, a result that can be compared automatically to other types of supplied information: data extracted from the SIM, or other symbols inscribed on the document, etc.

Inserting information matrices into bar codes will now be described. In a similar way to inserting a message distributed over all of a SIM's cells, a SIM can itself being inserted in the cells of a 2D bar code, for example a Datamatrix (registered trademark). As the SIMs have a high level of inking, in theory they will not interfere with the reading of the 2D bar code.

In an advantageous variant, each black cell of a Datamatrix contains a SIM. If the application's constraints allow it, each SIM comprises a different message, in which, for example, one part is fixed and the other part comprises an indicator that can be associated to the position of the cell in the Datamatrix.

1-31. (canceled)

32. A method for securing a document, that comprises:
a step of determining print conditions of said document;
a step of determining physical characteristics of cells of at least one shape, according to the print conditions, such that the proportion of cells printed with a print error coming solely from unanticipated unknowns in printing is greater than a pre-defined first value and less than a pre-defined second value;
a step of representing an item of information by varying the appearance of cells presenting said physical characteristics and
a step of printing said shape utilizing said print conditions, said shape being designed to enable the detection of a copy modifying the appearance of a plurality of said cells.

33. A method according to claim 32, wherein, during the step of determining the physical characteristics of cells, the dimension of the cells to be printed is determined.

34. A method according to claim 32, wherein, during the step of determining the physical characteristics of cells, a sub-section of the cells is determined, a sub-section that has a uniform and variable color for representing different values of an item of information, said sub-section being strictly less than said cell.

35. A method according to claim 34, wherein the pre-defined first value is greater than 5%.

36. A method according to claim 34, wherein the pre-defined first value is greater than 15%.

37. A method according to claim 34, wherein the pre-defined second value is less than 30%.

38. A method according to claim 32, that further comprises a step of generating the shape in a digital information matrix representing a message comprising redundancies.

39. A method according to claim 38, wherein, during the step of generating the shape, said information matrix represents, at the level of each elementary cell and independently of the neighboring elementary cells, the message comprising the redundancies.

40. A method according to claim 38, wherein, during the step of generating the shape, the redundancies are designed to allow the detection of unconnected marking errors in the mark produced during the step of printing.

41. A method according to claim 38, wherein, during the step of printing, a robust additional mark bearing a message is added to the information matrix.

42. A method according to claim 38, wherein, during the step of generating the shape, there is a sufficient proportion of redundancies to allow an error proportion greater than said pre-defined first value to be corrected.

43. A method according to claim 38, wherein, during the step of generating the shape, said redundancies comprise error-correcting codes.

44. A method according to claim 38, wherein, during the step of generating the shape, said redundancies comprise error-detecting codes.

45. A method according to claim 38, wherein, during the step of generating the shape, a representation of said message is encrypted with an encryption key.

46. A method according to claim 38, wherein, during the step of generating the shape, the positions of elements of the representation of said message are swapped according to a secret key.

47. A method according to claim 38, wherein, during the step of generating the shape, a value substitution function, which is dependent, on the one hand, on the value of the element and, on the other hand, on the value of an element of a secret key, is applied, to at least one part of the elements of a representation of said message.

48. A method according to claim 38, wherein, during the step of generating the shape, a digital information matrix is generated representing at least two messages provided with different means of security.

49. A method according to claim 48, wherein one of said messages at least represents information required, on reading the information matrix, to determine the other message and/or detect the other message's errors.

50. A method according to claim 38, wherein, during the step of generating the shape, a hash of said message is added to a representation of the message.

51. A device for securing a document, that comprises:
a means of determining print conditions of said document;
a means of determining physical characteristics of cells of at least one shape, according to the print conditions, such that the proportion of cells printed with a print error coming solely from unanticipated unknowns in printing is greater than a pre-defined first value and less than a pre-defined second value;
a means of representing an item of information by varying the appearance of cells presenting said physical characteristics and
a means of printing said shape by utilizing said print conditions, said shape being designed to enable the detection of a copy modifying the appearance of a plurality of said cells.
